(19) United States
(12) Patent Application Publication
(10) Pub. No.: US 2010/0131251 A1
(43) Pub. Date: May 27, 2010

(54) SHORTEST PATH SEARCH METHOD AND DEVICE

(75) Inventor: Tatsuhiko SUZUKI, Atsugi (JP)

Correspondence Address: Fujitsu Patent Center;C/O CPA Global, P.O. Box 52050, Minneapolis, MN, 55402, US

(73) Assignee: FUJITSU LIMITED, Kawasaki-shi (JP)

(21) Appl. No.: 12/695,305

(22) Filed: Jan. 28, 2010

(30) Foreign Application Priority Data
Jan. 29, 2006 (JP) 2009-017665

(51) Int. Cl. G06F 17/10

(52) U.S. Cl. 703/2

(57) ABSTRACT

A shortest path search method executed by a computer includes steps of: storing data on vertices and data an interpolation points provided on each edge of each triangle of a triangular mesh in association with data of corresponding triangles and sides; accepting a specification of a departure point or curve and an arrival point or curve on the three-dimensional model; and searching sequentially for the interpolation points and the vertices from the departure point or curve to the arrival point or curve based on topological information of the triangular mesh, calculating a distance from the departures point or curve to the interpolation point or the vertex, and if the distance is the shortest among all paths, storing the distance.

### CROSS-REFERENCE TO RELATED APPLICATIONS

This application is based upon and claims the benefit of priority of the prior Japanese Patent Application No. 2009-17665, filed on Jan. 29, 2009, the entire contents of which are incorporated herein by reference.

### FIELD

The present invention is related to a technique for searching for a shortest path between departure curve (including contraction cases to a point) and arrival curve (including contraction cases to a point) on a three-dimensional model.

### BACKGROUND

Since there are cases where an electrical discharge occurs along the surface of the electric/electronic device between conductors exposed on the surface, automatic calculation of a shortest path and a shortest distance between conductors is often required in designing an electric/electronic device. Since even high-power electronic devices are often downsized, automatic calculation of a shortest path distance between conductors is beneficial in reducing design time.

For example, as illustrated in FIG. 1A and FIG. 1C, when a depression has a width of less than 1 mm between two conductors 1001 and 1002, a shortest path is identified in a state where the depression is ignored, and the path length of the shortest path is referred to as a creepage distance. While a depression has a width of 1 mm or greater between the conductors 1001 and 1002 as illustrated in FIG. 1B, a shortest path is identified following the inside of the depression, whereby the path length of the shortest path is similarly a creepage distance. On the other hand, when there exists a protrusion between the conductors 1001 and 1002 as illustrated in FIG. 1D, a shortest path is identified following the protrusion.

Conventionally, there are several techniques for calculating a shortest path between a path departure point and a path arrival point in a triangular mesh in a three-dimensional model such as a CAD model. One such method is the weighted graph search method. As illustrated in FIG. 2, in the weighted graph search method a surface of an object is approximated to a graph and a shortest path between two vertices on the graph is searched for. In FIG. 2, two vertices are connected by a weighted arc (also referred to as edge). Movement is allowed between two vertices only if an arc has been defined between them, whereby the cost of movement is the weight. Specific examples of shortest path search algorithms include Dijkstra's algorithm.

Dijkstra's algorithm is one of the methods for searching for a path such that minimizes the sum of positive weights of arcs from a node s to another node t in a graph G (N, A), where N denotes a set of nodes (also referred to as verteces) and A denotes a set of arcs (also referred to as edges) connecting the nodes. Hereinafter, an outline of Dijkstra's algorithm will be presented.

Premise: The graph G is connected and a weight w attached to an arc is positive. A distance d(vᵢ) from a starting node s and a return node (immediately preceding node) r(vᵢ) are adjoined to a node vᵢ.

Algorithm:

1. Initial process: Divide the set of nodes N into the following two sets.
Set of calculated nodes C={s}, where { . . . } denotes a set.
Set of uncalculated nodes U=N−{s}

Set distance as follows.
d(s)=0, d(v)=∞, where vεU.

2. Computation: For every yεU adjacent to nodes xεC having maximum distance d,

if d(x)+w_{xy}<d(y)

then d(y)=d(x)+w_{xy}
Search a node zεU having a shortest distance d, and set U=U−{z}, C=C∪{z}.
Save return node r(z)=x.
Repeat this process until z=t.

A shortest path is identified by tracing the saved return node information.

In Dijkstra's algorithm, arcs must first be statically prepared between all adjacent nodes. In other words, a search may not be performed until a graph such as that illustrated in FIG. 2 is composed completely. However, since an arc and a weight are always defined between nodes, there is a problem that an increase of nodes results in a significant increase of the data volume.

In consideration thereof, there is a technique that addresses such problems. That is, with this technique, while searching a graph, the graph is dynamically created only for a portion required by the search. First, (1) a problem area is divided, (2) a graph is created only for an area that includes a starting node, (3) a search for the shortest path is started from this area, and once the search proceeds to a node on the boundary of the area, a graph of an adjacent area is created. Thereafter, the graph of the currently-searched area and the created graph of the adjacent area are merged. The process of (3) is repeated until the search reaches an end node. In such processing, however, there occurs a problem in that processing becomes complicated such as area division and graph merging.

Moreover, while a graph such as that illustrated in FIG. 2 is formed in a shape that conforms to the surface of a 3D model, the arrangement of nodes and arcs are not necessarily optimal. Then, a starting node and an end node cannot be truly connected by the shortest distance by simply following an arc set between nodes which are identified as the shortest path. There are also techniques that address such problems. One of those techniques develops starting and end nodes on a plane including them to calculate a linear distance between them, and compensate nodes between them.

For example, a graph set on the surface of a hexahedron illustrated in FIG. 3A is searched by, for example, Dijkstra's algorithm to calculate an initial shortest path from a starting node to an end node. In FIG. 3A, an initial shortest path having an order of the starting node, I1, V, I2, and the end node is identified. Subsequently, as illustrated in FIG. 3B, an initial planar development is performed around a vertex V of the hexahedron included in the initial shortest path. Specifically, triangles T5, T2, T3, and T4 are developed into a single plane. Then, by connecting the node I1 that is a node included in the triangle T2 that is closest to the starting node and the end node with a straight line, a path that is shorter than a path via the vertex V is identified. In this case, a path having an order of the starting node, I1, I3, I4, and the end node is identified. The nodes I3 and I4 have been newly identified. Subsequently, a triangle T1 including the starting node and triangles T2, T3, and T4 are developed into a single plane. Next, by connecting the starting node and the end node with a straight line, as illustrated in FIG. 3C, the path is to now include newly identified nodes I1′, I3′, and I4′. However, the technique optimizes a path in two stages, thereby making the processing complicated.

Such techniques are disclosed in, for example, Japanese Patent Laid-Open No. 2006-172318 and Japanese Patent Laid-Open No. 2008-134948.

### SUMMARY

According to an aspect of the invention, a shortest path search method for searching for a shortest path on a three-dimensional model executed by a computer includes steps of: providing interpolation points on each edge of each triangle of a triangular mesh of the three-dimensional model; storing, in a processing data storage unit, data on vertices of each triangles and data on the interpolation points with the data of the corresponding triangles and edge; accepting a specification of a departure point or a departure curve and an arrival point or an arrival curve on the three-dimensional model; and searching the interpolation points and the vertices sequentially from the departure point or the departure curve to the arrival point or the arrival curve based on topological information of the triangular mesh, calculating a distance from the departure point or the departure curve to the interpolation point or the vertex that is a shortest distance search object point, and if the calculated distance is the shortest among all paths, associating the calculated distance with the interpolation point or the vertex that is the shortest distance search object point, and storing the calculated distance as a shortest distance in the processing data storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1D are diagrams for describing creepage distance;

FIG. 2 is a diagram illustrating an example of a weighted graph;

FIGS. 3A to 3C are diagrams for describing conventional techniques;

FIG. 4 is a diagram illustrating an example representing a path from a path departure curve to a path arrival curve on a three-dimensional model;

FIG. 5 is a functional block diagram of a shortest path search device;

FIG. 6 is a diagram for describing a topological structure of a mesh;

FIG. 7 is a diagram illustrating an example of a triangular mesh;

FIG. 8 is a diagram illustrating an example of a point table;

FIG. 9 is a diagram illustrating an example of a triangle table;

FIG. 10 is a diagram illustrating an example of a topology table;

FIG. 11 is a diagram illustrating an example of a cosine table;

FIG. 12 is a diagram illustrating an example of an edge length table;

FIG. 13 is a diagram illustrating an example of a processing flow of shortest path search processing;

FIG. 14 is a diagram for describing an interpolation point;

FIG. 15 is a diagram illustrating an example of an interpolation point data table;

FIG. 16 is a diagram illustrating an example of an interpolation point management table;

FIG. 17 is a diagram for describing a return point;

FIG. 18 is a diagram for describing why arc data between interpolation points is not generated;

FIG. 19 is a diagram illustrating an example of a front candidate point set table;

FIG. 20 is a diagram illustrating an example of a front candidate point set table in a case where a heap structure is adopted;

FIG. 21 is a diagram illustrating a processing flow of shortest path search processing;

FIG. 22 is a diagram for describing a triangular element to be searched;

FIG. 23 is a diagram for describing a triangular element to be searched;

FIG. 24 is a diagram for describing a triangular element to be searched;

FIG. 25 is a diagram for describing a triangular element to be searched;

FIG. 26 is a diagram for describing a triangular element to be searched;

FIG. 27 is a diagram for describing a triangular element to be searched;

FIG. 28 is a diagram for describing calculation of an inter-triangle distance;

FIG. 29 is a diagram for describing a specific example of shortest path search processing;

FIG. 30 is a diagram for describing a specific example of shortest path search processing;

FIG. 31 is a diagram for describing a specific example of shortest path search processing;

FIG. 32 is a diagram for describing a specific example of shortest path search processing;

FIG. 33 is a diagram for describing a specific example of shortest path search processing;

FIG. 34 is a diagram for describing a specific example of shortest path search processing;

FIG. 35 is a diagram for describing a specific example of shortest path search processing;

FIG. 36 is a diagram for describing a specific example of shortest path search processing;

FIG. 37 is a diagram for describing a specific example of shortest path search processing;

FIG. 38 is a diagram for describing a specific example of shortest path search processing;

FIG. 39 is a diagram for describing a specific example of shortest path search processing;

FIG. 40 is a diagram for describing a specific example of shortest path search processing;

FIG. 41 is a diagram for describing a problem that may occur during shortest path search processing;

FIG. 42 is a diagram for describing a planar development segment;

FIG. 43 is a diagram for describing a condition of a planar development segment end point;

FIG. 44 is a diagram for describing a condition of a planar development segment end point;

FIG. 45 is a diagram illustrating a processing flow of planar development path distance correction processing;

FIG. 46 is a diagram illustrating another example of an interpolation point management table;

FIG. 47 is a diagram illustrating a processing flow of planar development segment generation processing;

FIG. 48 is a diagram for describing planar development segment generation processing;

FIG. 49 is a diagram illustrating a processing flow of planar development segment generation processing;

FIG. 50 is a diagram illustrating a processing flow of interpolation point position compensation processing;

FIG. 51 is a diagram illustrating a processing flow of position compensation processing;

FIG. 52 is a diagram for describing position compensation processing;

FIG. 53 is a diagram illustrating a processing flow of position compensation processing;

FIG. 54 is a diagram for describing position compensation processing;

FIG. 55 is a diagram for describing phase information; and

FIG. 56 is a functional block diagram of a computer.

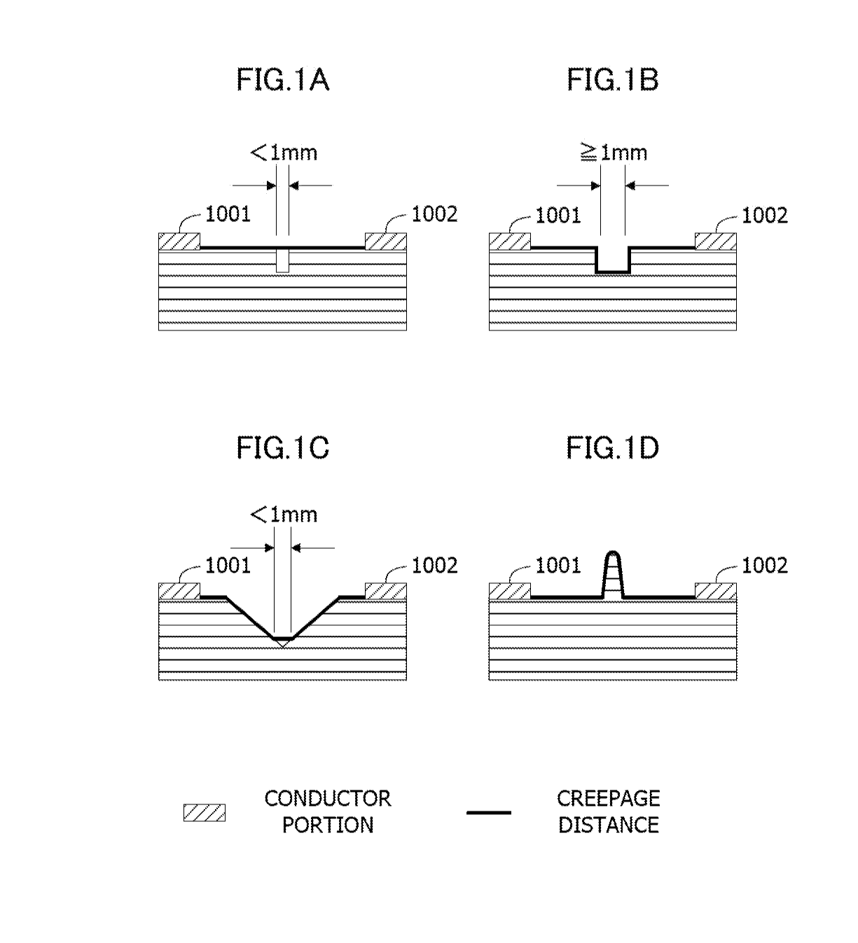

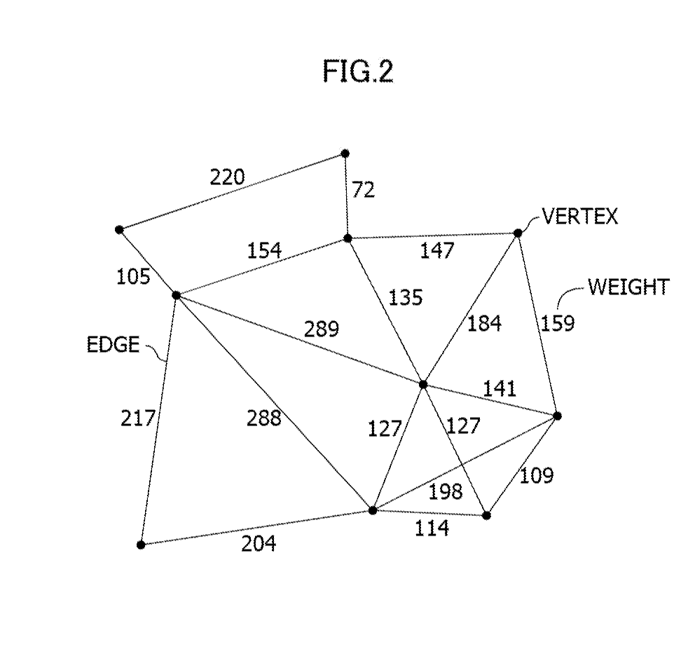

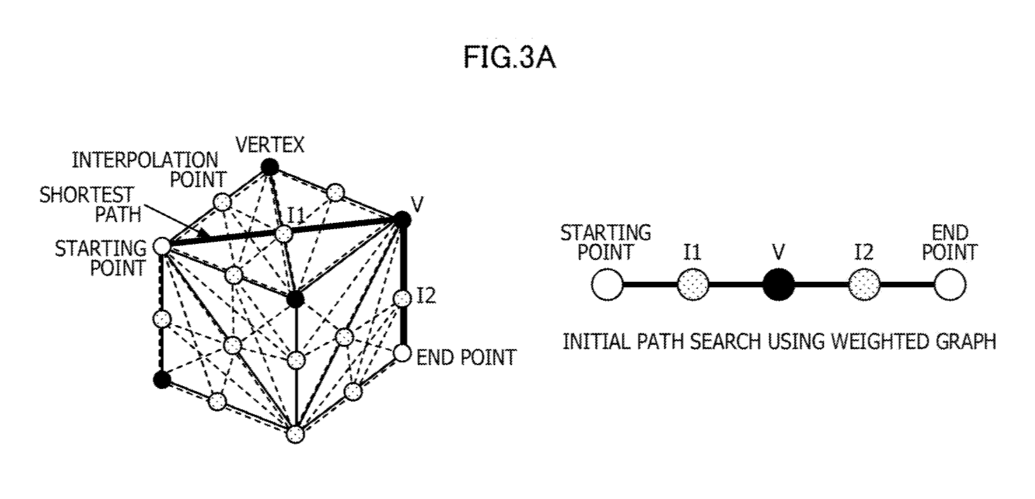

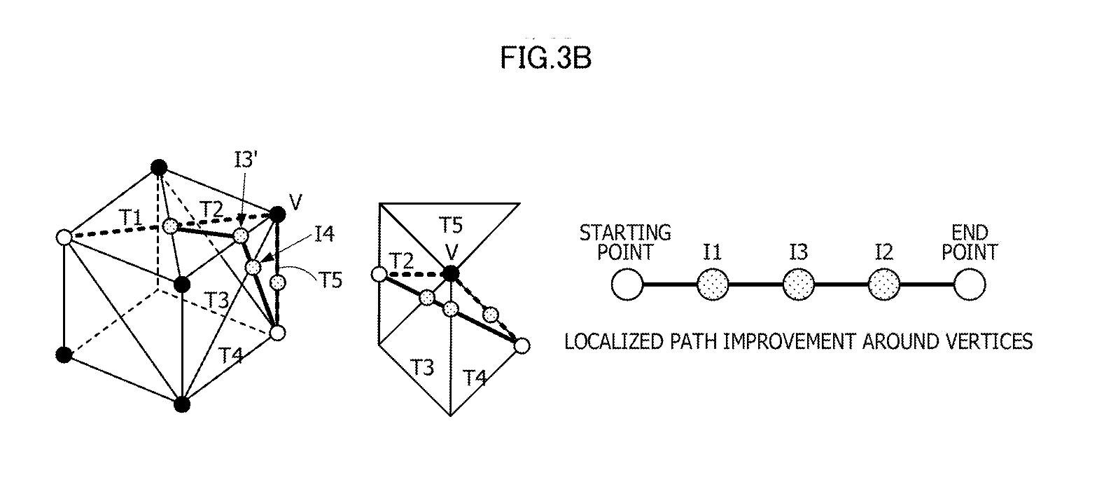

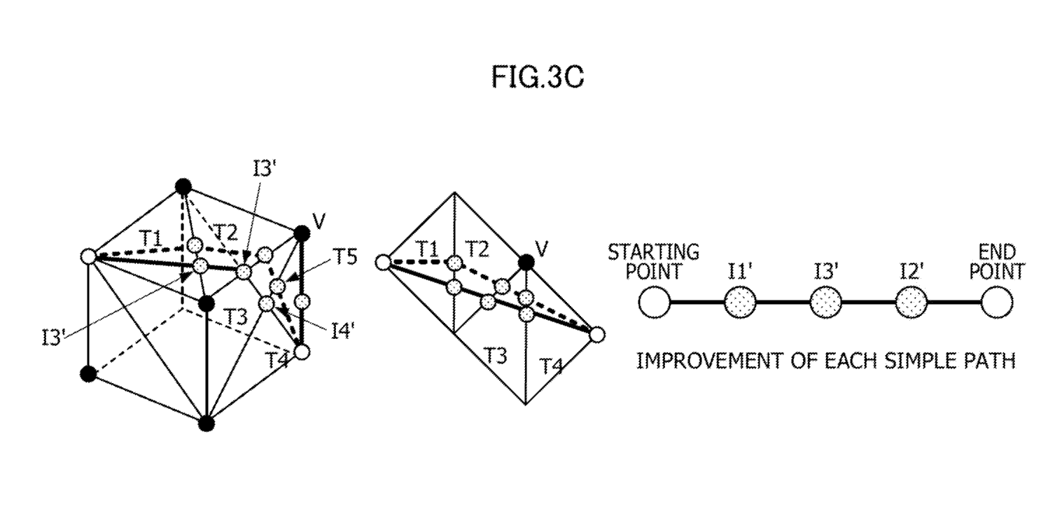

### DESCRIPTION OF EMBODIMENTS

As described above, conventional art contains various problems. What is particularly problematic is that there are no techniques capable of identifying a shortest path between a path departure curve and a path arrival curve. While methods such as Dijkstra's algorithm are useful in identifying a shortest path between two nodes, the methods are ill-suited to identify a shortest path between two curves in the same manner.

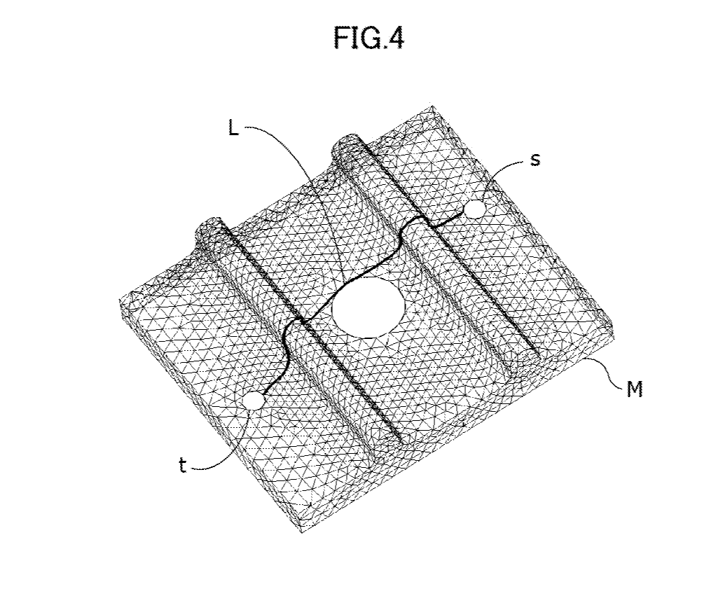

In an embodiment of the present invention, as illustrated in FIG. 4, it is assumed that a shortest path L from a path departure curve (or path departure curves) s to a path arrival curve (or path arrival curves) t on a three-dimensional model M is to be identified and a shortest distance that is the length of the shortest path L is to be calculated. When doing so, a triangular mesh is formed by a known method on the three-dimensional model M and interpolation points are set so as to improve accuracy on the respective edges of the triangles. However, edges connecting interpolation points are not formed and then retained and used in advance. When searching vertices and interpolation points of a triangular mesh to identify a shortest path, distances between interpolation points and vertices of the triangular mesh are desired. However, distances are calculated on an as-needed basis. In this manner, by not preparing arcs connecting interpolation points in advance, processing time may be reduced and an increase in the data volume may be minimized.

In addition, when distances are calculated based on positions of initially generated interpolation points, the distance between a departure point and an end point may not be the shortest distance. Therefore, a shortest distance with higher accuracy is calculated by performing, to the extent possible, planar development on the triangles of the triangular mesh and connecting the triangles with straight lines. Furthermore, when forming straight lines, the positions of interpolation points are also compensated.

Hereinafter, a specific configuration for realizing such processing will be described.

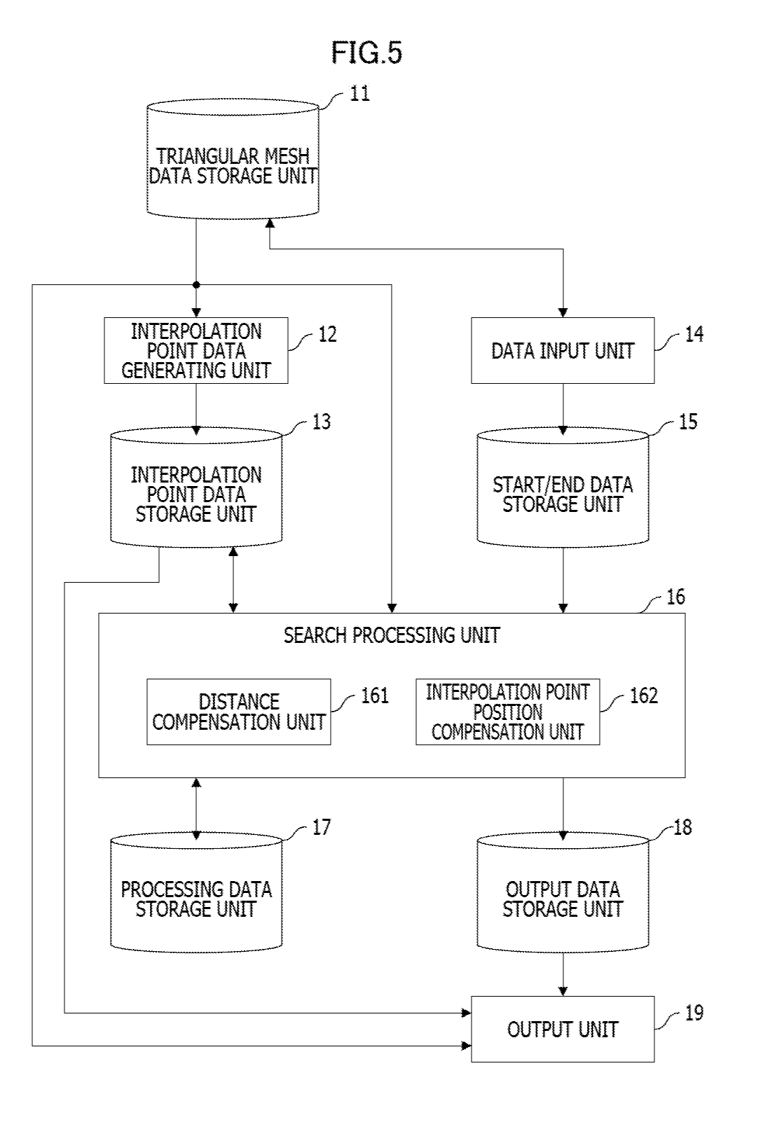

A functional block diagram of a shortest path search device according to the present embodiment is illustrated in FIG. 5. The shortest path search device includes, for example, a triangular mesh data storage unit 11 for storing data of a triangular mesh formed by a known technique with respect to a three-dimensional model specified by a user. In addition, the shortest path search device includes, for example: a data input unit 14 that allows the user to input one or more path departure curves and one or more path arrival curves for a path search using data stored in the triangular mesh data storage unit 11; a start/end data storage unit 15 for storing data on the one or more path departure curves and the one or more path arrival curves inputted from the data input unit 14; an interpolation point data generating unit 12 that performs processing for generating an interpolation point on an edge of a triangle using data stored in the triangular mesh data storage unit 11; and an interpolation point data storage unit 13 that stores data generated by the interpolation point data generating unit 12. The shortest path search device further includes: a search processing unit 16 that performs processing for searching a shortest path using data stored in the interpolation point data storage unit 13, the triangular mesh data storage unit 11, and the start/end data storage unit 15; a processing data storage unit 17 that temporarily retains data to be used in the processing of the search processing unit 16; an output data storage unit 18 that stores shortest distance data and shortest path data which are processing results of the search processing unit 16; and an output unit 19 that presents a shortest distance and a shortest path to the user using, for example, the triangular mesh data storage unit 11, the output data storage unit 18, and the interpolation point data storage unit 13.

The search processing unit 16 includes: a distance compensation unit 161 that performs processing for distance compensation on at least a portion of a path; and an interpolation point position compensation unit 162 that performs processing for interpolation point position compensation when distance compensation is performed on at least a portion of a path.

Next, data stored in the triangular mesh data storage unit 11 will be described. First, a mesh will be described. It is impractical to precisely represent a complicated shape of an object. Therefore, generally, an object is represented as a polyhedral mesh. In particular, triangular meshes are readily generated and handled and are therefore commonly used. Triangular meshes are also advantageous when performing processing using planar development to be described later.

A triangle is defined by three vertices. A mesh is a set of triangles, whereby an edge that is not a boundary is shared by two triangles. A vertex is shared by one or more triangles.

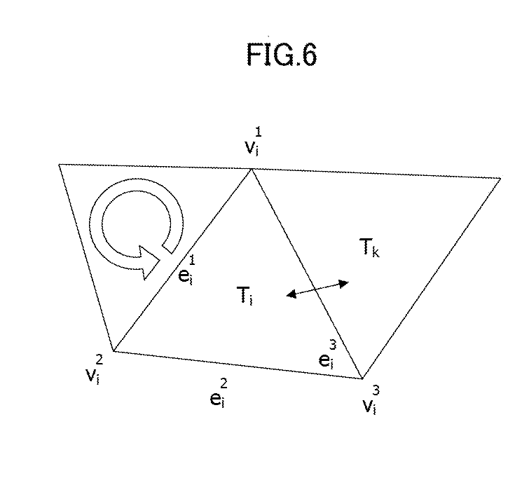

As illustrated in FIG. 6, an identifier is assigned to a triangle Tᵢ, and for each triangle Tᵢ, reference characters vᵢⱼ, where jε[1, 3], and eᵢⱼ, where j ε[1, 3] are assigned to the vertices and the edges respectively to represent a topological structure (a connection relationship between elements) of the mesh. The triangle is orientated as indicated by the white arrow in FIG. 6. Since the orientation is coherent in the entire mesh, adjacent vertices, edges, and triangular elements may now be uniquely oriented in a non-contradictory manner. In addition, as indicated by the black arrow in FIG. 6, for each triangle, a triangle that is adjacent via an edge is uniquely defined. Furthermore, an adjacent triangle may be identified by using vertices having similar identifiers. Moreover, since an edge may be identified using vertices, in some cases, the edges may not be managed.

While a triangular mesh is generated using various known techniques, a triangular mesh generated to be used in the finite element method (FEM), for example, is preferable. A triangular mesh generated in this manner has a favorable aspect ratio and therefore will result in high accuracy.

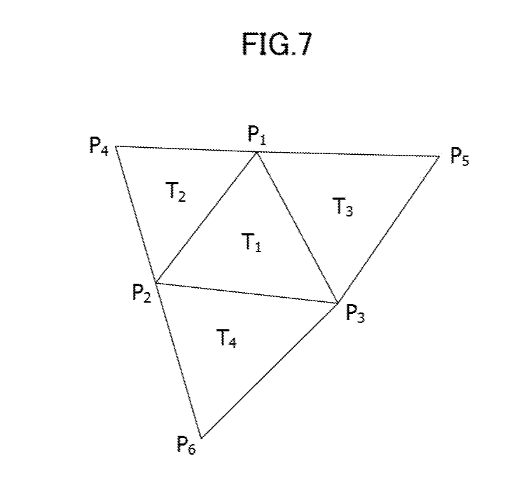

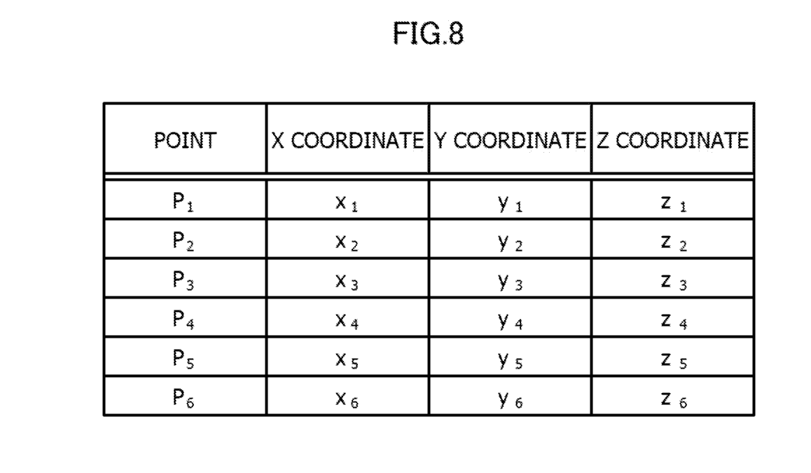

In the present embodiment, under the above-described premises, triangular mesh data includes a point table, a triangle table, and a topology table. Here, for example, a case will be described where a triangular mesh such as that illustrated in FIG. 7 exists. In FIG. 7, six vertices and four triangles are identified. An example of the point table on such a triangular mesh is illustrated in FIG. 8. In the example of FIG. 8, an X coordinate, a Y coordinate, and a Z coordinate are registered for each vertex identifier.

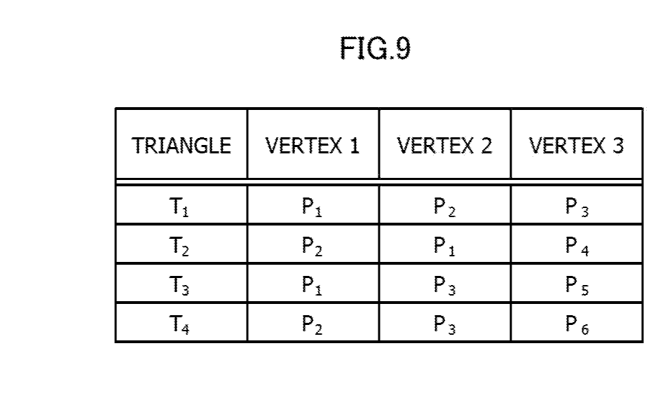

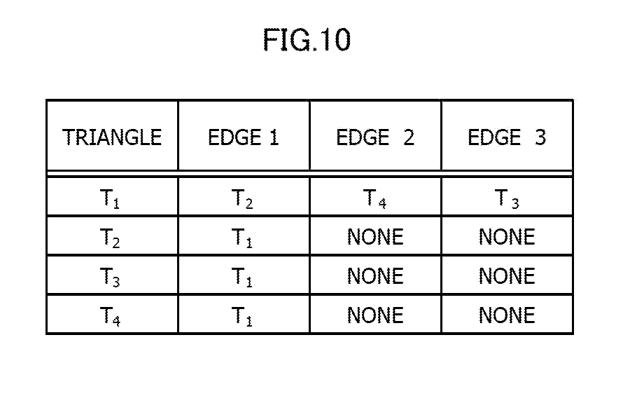

An example of the triangle table is illustrated in FIG. 9. In the example of FIG. 9, identifiers of three corresponding vertices are registered for each triangle identifier. Furthermore, an example of the topology table is illustrated in FIG. 10. In the example of FIG. 10, identifiers of triangles adjacent to the respective edges are registered for each triangle identifier. Note that the order of edge 1, edge 2, and edge 3 is constant as indicated by the white arrow illustrated in FIG. 6.

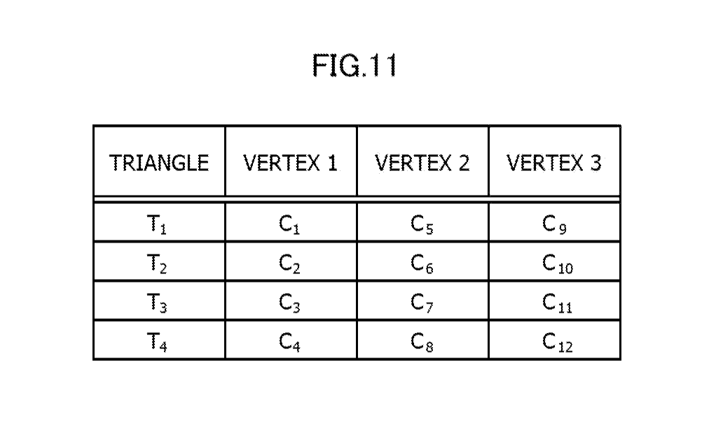

In addition to the tables described above, the distance calculation speed may be increased by retaining the tables described below. However, these tables are not essential. A first table for increasing the calculation speed is a cosine table such as that illustrated in FIG. 11. In the example illustrated in FIG. 11, for each vertex of each triangle, a cosine value in accordance with an angle of the vertex is registered. By preparing such data in advance, the distance between two vertices or two interpolation points of a triangle may be calculated at a higher speed.

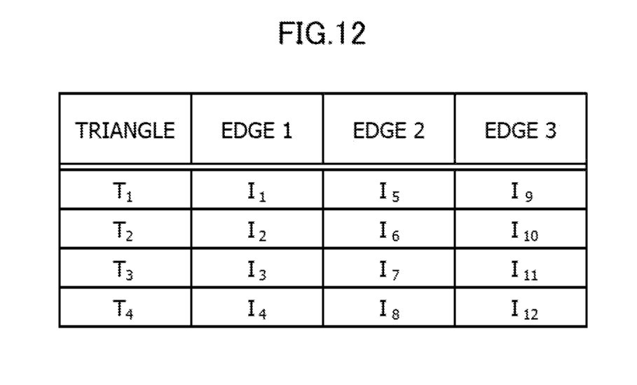

In addition, a second table to speed up the calculations is an edge length table such as that illustrated in FIG. 12. In the example illustrated in FIG. 12, the length of each edge is registered for each triangle. By retaining such data, the speed of calculation of distances inside the triangle may be increased.

Moreover, in some cases, refraction index corresponding to a degree of insulation is registered for each triangular mesh in the triangular mesh data storage unit 11. To calculate the shortest distance (e.g., creepage distance) of an object, the material, and therefore, the degree of insulation of each triangle existing on a path may differ from each other. Then, it is necessary to calculate distances according to the degrees of insulation. By registering the refraction index corresponding to the degree of insulation, a distance may be converted by multiplying the distance with the refraction index for corresponding portions in the distance calculation to be described below.

In the present embodiment, a description will be given on the premise that triangular mesh data, such as the data described above, is prepared in advance in the triangular mesh data storage unit 11. However, the shortest path search device may alternatively be provided with a function that generates triangular mesh data, such as the data described above, from data of a three-dimensional model (for example, data of a three-dimensional model described by a free-form curved surface such as a Bezier surface, a B-Spline surface, or a NURBS surface, or data of a three-dimensional model composed of a plurality of parts).

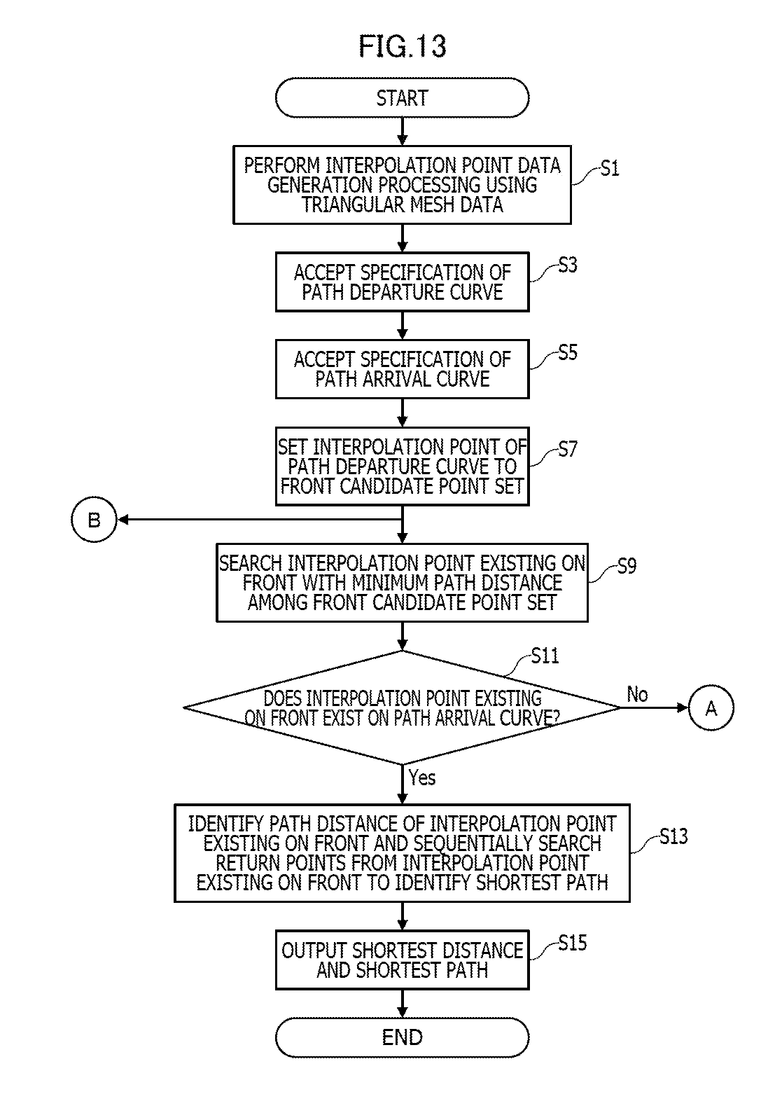

Next, processing performed by the shortest path search device will be described with reference to FIGS. 13 to 54.

First, the interpolation point data generating unit 12 performs interpolation point data generation processing using triangular mesh data stored in the triangular mesh data storage unit 11 (FIG. 13: step S1). In this processing, interpolation points (also referred to as “Steiner points”) are added to each edge of each triangle included in the triangular mesh. When the triangular mesh has a certain degree of normality or, in other words, when a minimum angle of a triangle is greater than a threshold, it is practical to arrange interpolation points uniformly so that the number of interpolation points per edge becomes constant. However, the number of interpolation points may also be determined according to the length of an edge so as to arrange the interpolation points at equal intervals.

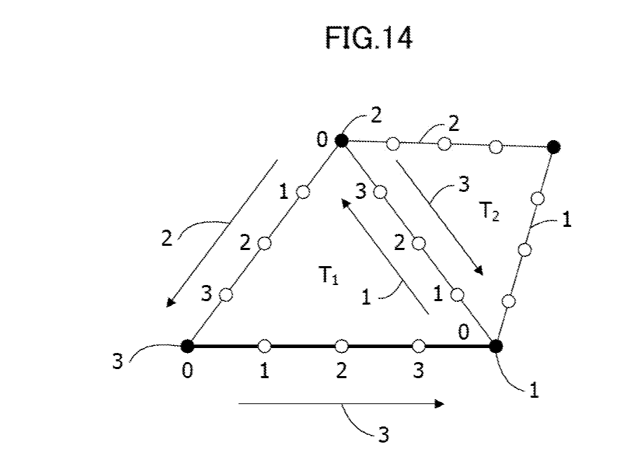

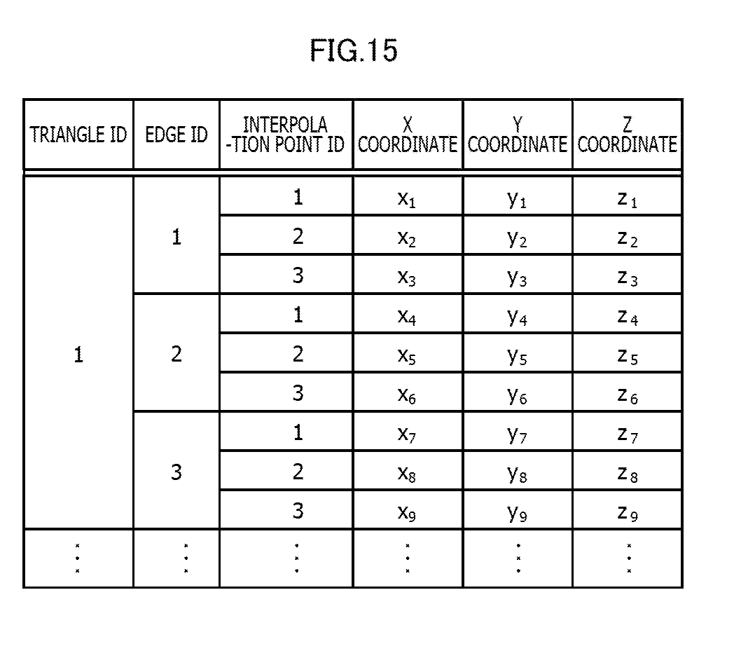

For example, when there exist triangles T₁ and T₂ as illustrated in FIG. 14, interpolation points 1 to 3 are added to the respective edges. As positional data of the interpolation points 1 to 3, as illustrated in FIG. 15, an X coordinate, a Y coordinate, and a Z coordinate may be registered in correspondence to IDs of a relevant triangle, edge, and interpolation point. However, for example, when three interpolation points are set to an edge, coordinate positions of interpolation points need not be calculated in advance as long as it is determined that the interpolation points be placed at positions equaling, for example, ¼, ½, and ¾ of the edge, because such determination allows calculation of an inner-triangle distance. However, when the numbers of interpolation points vary from edge to edge, it may be preferable to prepare the data illustrated in FIG. 15.

As indicated by the white arrow in FIG. 6, IDs are assigned in a certain direction. That is, in FIG. 14, numbers 1 to 3 are assigned counter-clockwise to edge as indicated by the arrow, and numbers 1 to 3 are assigned counter-clockwise to interpolation points on the edges. However, in the following processing, since it is favorable to uniformly process the vertices (black dots) with the interpolation points, an interpolation point number of “0” is assigned to the vertices.

In addition, as is apparent from FIG. 14, the edge 1 of the triangle T₁ and the edge 3 of the triangle T₂ are shared and have the same interpolation points. Therefore, regarding positional data as illustrated in FIG. 15, though the IDs of triangles, edges, and interpolation points might differ, the same positional data may be registered.

In search processing described below, in order to manage interpolation point data, an interpolation point management table is generated.

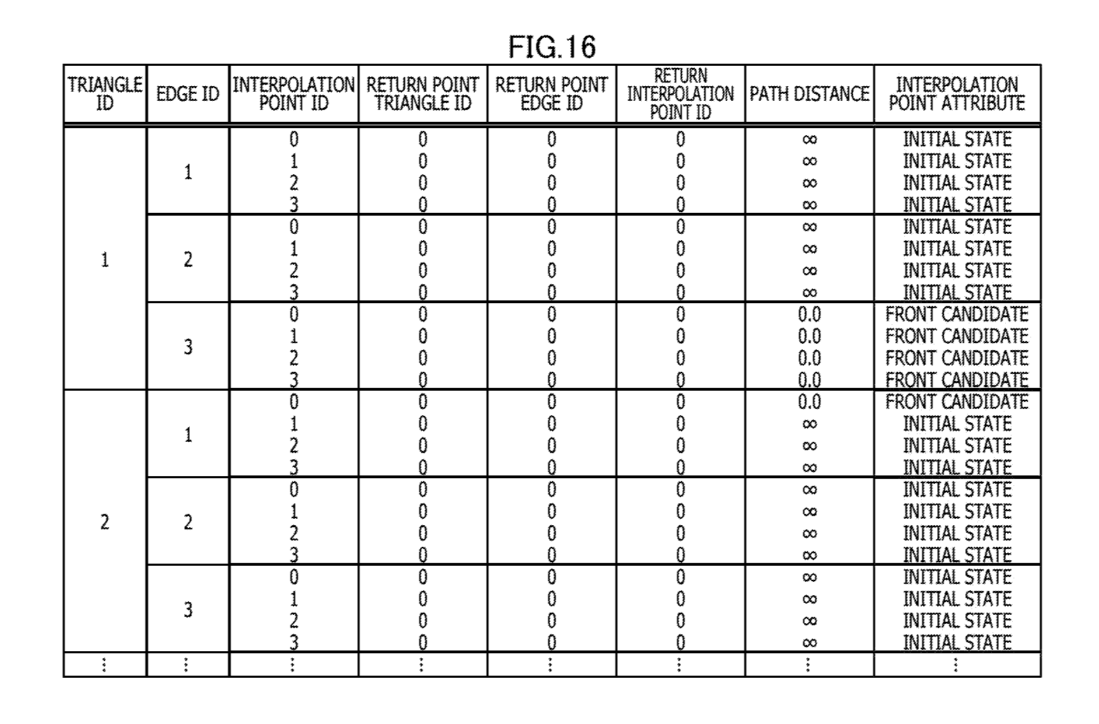

The interpolation point management table is illustrated in FIG. 16, for example. In FIG. 16, corresponding to a triangle ID, an edge ID, and an interpolation point ID, an ID of a return point triangle that is a triangle including a return point which is an interpolation point (in some cases, a vertex) immediately preceding the relevant interpolation point, an ID of a return point edge that is an edge including a return point, an ID of a return interpolation point that is a return point, a path distance to the relevant interpolation point, and interpolation point attributes are registered.

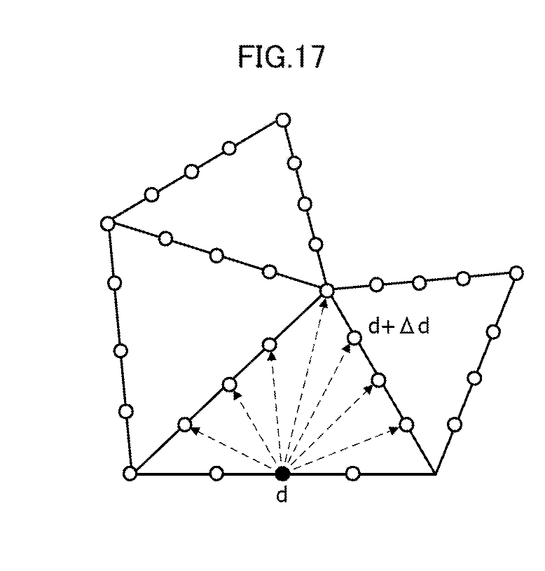

As for return points, for example as illustrated in FIG. 17, when searching for interpolation points (including vertices) on the edges of the same triangle from an interpolation point shown as a black dot, the interpolation point shown as the black dot becomes a return point from a search target interpolation point shown as a white dot. However, as is apparent from the processing described below, since a return point and a path distance are not registered if the path distance is not the shortest for the search target interpolation point, the return point for the search target interpolation point is the next-to-last interpolation point on the shortest path at that moment. This enables a backward trace of the path.

Transition of an interpolation point attribute starts from an “initial state”, to a “front candidate” state, and to a “front passage complete” state. Before a search the attribute of interpolation is an initial state. Next, an interpolation point on a path departure curve described below changes to a state referred to as a front candidate state. A search is performed from the front candidate state to the next interpolation point. When the search for the front candidate state is completed, the state changes to front passage complete state. In addition, an interpolation point attribute may be represented using a sign (positive or negative) of a path distance or return point information.

In the present step, “0” is initially registered as the return point triangle ID, the return point edge ID, and the return interpolation point ID, and a value corresponding to infinity is set as the path distance.

In addition, as illustrated in FIG. 14, since the triangle T₁ and the triangle T₂ share an edge, interpolation points are also shared. When data on the three edges of all triangles is retained as illustrated in FIG. 16, some identical interpolation points may correspond to two or more records in the table. In such a case, both records are preferably updated synchronously. Alternatively, one of the records may be always handled as a representative record while the other records may remain un-updated.

In some case path distances may be registered in a front candidate point set table, which will be described below, and may not be retained in the interpolation point management table.

In the interpolation point management table, though return point information for backward trace of a path is registered, arcs connecting interpolation points and their distances are not defined. This enables not only processing time for calculating arcs and distances thereof to be reduced, but also the amount of data to be retained to be reduced significantly.

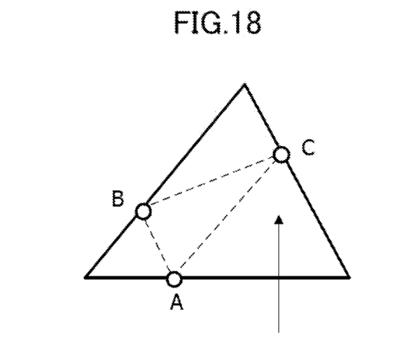

Here is a remarkable calculation technique. Now assume, as illustrated in FIG. 18, that a search is performed in the direction of the arrow and has currently reached an interpolation point A. Then, the distance from a departure curve via the interpolation point A to an interpolation point B is the sum of a distance d from the departure curve to the interpolation point A and a distance AB between the interpolation points A and B; while the distance from a departure curve via the interpolation point A to an interpolation point C is the sum of the distance d to the interpolation point A and a distance AC between the interpolation points A and C. Though the interpolation point C from the interpolation point A via the interpolation point B may be reached, the distance when directly proceeding to the interpolation point C from the interpolation point A is always shorter. Thus the path in the order of interpolation points A, B, and C cannot be adopted. Therefore, an inter-triangle search such as described above is not performed in the search processing described below, and the processing for defining an arc between the interpolation points B and C and calculating the distance of the arc is needless. In the present embodiment, a shortest path search may be performed at a high speed without performing such needless processing.

Returning now to the description of the processing illustrated in FIG. 13, the data input unit 14 prompts the user to specify one or more path departure curves, accepts specification of the one or more path departure curves from the user, and stores data for identifying the one or more path departure curves in the start/end data storage unit 15 (step S3). For example, mesh data may be read from the mesh data storage unit 11 and display data of the three-dimensional model may be generated and displayed to have the user specify path departure curves. The path departure curves are boundaries of a triangular mesh. Alternatively, the user may specify one or more points, search for and identify mesh boundaries nearest to the specified points, and acquire the one or more path departure curves as series of closed edges.

In a triangular mesh, a boundary of a conductor is represented by a series of closed sides as the path departure curve s and the path arrival curve t illustrated in FIG. 4. If an extremely thin conductor is to be ideally represented, a shortest path (e.g., creepage distance) between the series of closed edges may be calculated by using a series of closed edges represented as a boundary of empty triangular elements. In addition, a series of closed edges may be contracted to a single point. In this case, the problem is reduced to a path search from a single departure point.

Boundary data is identified by a set composed of triangle IDs and edge IDs. The data may be retained in a table format or a hash structure.

Furthermore, the data input unit 14 prompts the user to specify one or more path arrival curves, accepts specification of the one or more path arrival curves from the user, and stores data for identifying the one or more path arrival curves in the start/end data storage unit 15 (step S5). For example, mesh data may be read from the mesh data storage unit 11, and the three-dimensional model may be displayed to have the user specify the path arrival curves. The path arrival curves are boundaries of the triangular mesh. Alternatively, the user may specify one or more points, search for and identify the mesh boundary nearest to the specified point, and acquire the path arrival curves as series of closed edges.

Boundary data is identified by a set composed of triangle IDs and edge IDs. The data may be retained in a table format or a hash structure.

Moreover, the path departure curves and the path arrival curves may be generalized to those that are not boundaries of the triangular mesh. Since in the embodiment, the distance from one or more departure curves as a whole to interpolation points is calculated sequentially until a path reaches one of the arrival curves, the numbers of departure curves and arrival curves have no substantial meaning. Hereinafter, the case of one departure curve and one arrival curve is described for simplicity.

Next, the search processing unit 16 sets interpolation points of the path departure curve to the front candidate point set table (step S7). A front candidate point is an interpolation point that is a candidate of a source (an intermediate source except an interpolation point on a path departure curve) for searching for a shortest path such as the interpolation point depicted by the black dot in FIG. 17. The front candidate point set table is stored in, for example, the processing data storage unit 17.

In the present embodiment, a path distance from departure curve is determined by a secondary wave from an interpolation point on a Huygens front that is a wave front when the extension of a path distance is viewed as a wave. In other words, when a Huygens front passes an interpolation point, the secondary wave propagates to interpolation points of a triangular element to which the interpolation points belong and which is located in the wave direction. Subsequently, an interpolation point having a minimum path distance among interpolation points to which the secondary wave has propagated is assumed to be a via point of the next Huygens front. A front candidate point is an interpolation point that becomes a candidate of a via point of a Huygens front.

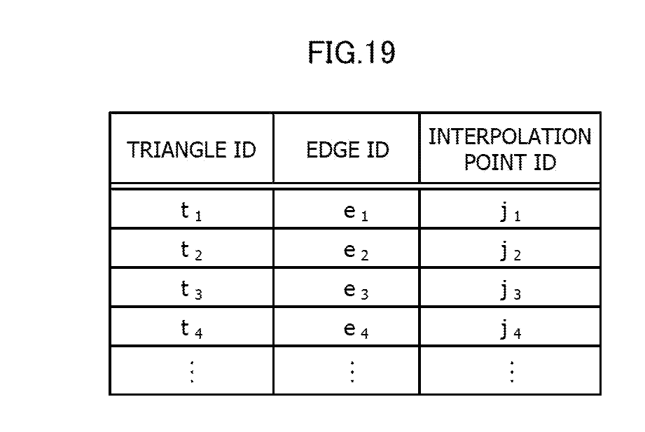

The front candidate point set table is illustrated in FIG. 19, for example. In the front candidate point table, a triangle ID, an edge ID, and an interpolation point ID are registered for each front candidate point. If an interpolation point is registered in the front candidate point set table, an interpolation point management table (FIG. 16) is also updated. In other words, a candidate attribute of a corresponding interpolation point is updated to “front candidate”. In addition, the path distance is also updated to a corresponding path distance, where, initially, “0” is registered as the path distance since the interpolation point of the path departure curve has a path distance of “0”.

When adding an interpolation point to the front candidate point set table, the interpolation point is added to, for example, the last record in the table. In addition, when deleting a front candidate point from the front candidate point set table, a corresponding record is deleted and then the last record is moved to the deleted record location.

Moreover, in the following processing, a process for extracting a front candidate point having a minimum path distance from a front candidate point set is frequently performed. If the number of front candidate points is small enough, sequential search of the interpolation point management table to identify a front candidate point having a minimum path distance will suffice processing time. However, the sequential search requires more time as the number of front candidate points increases. Then, a heap structure that manages corresponding addresses in the front candidate point set table is desirably used. However, since the front candidate point set table and a path distance change dynamically, it is essential to correlate the heap structure with the front candidate point set table.

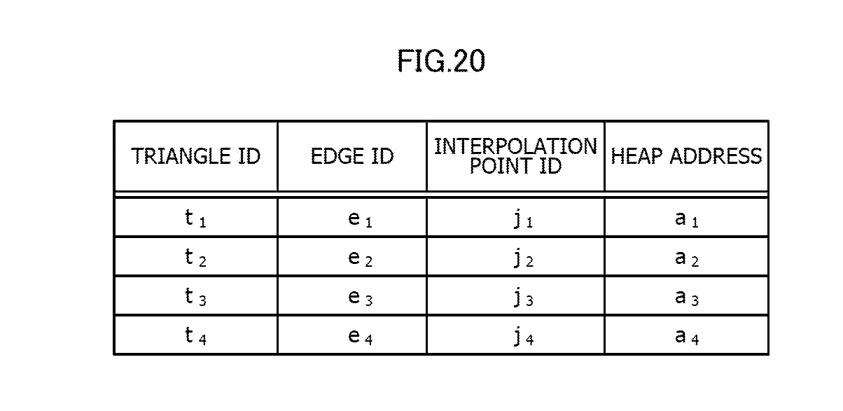

When adopting a heap structure, a data format such as that illustrated in FIG. 20 is adopted for the front candidate point set table. The example of FIG. 20 is arranged so that a heap address is to be registered in addition to the table illustrated in FIG. 19.

A heap structure is a binary tree composed of nodes having consecutive numbers and is a data structure having the following three rules.
(1) An address 1 is assumed to be a root.
(2) The left child of an address k is stored in an address 2k while the right child of the address k is stored in an address 2k+1.
(3) The data of a parent node is always smaller than the data of a child node.

By retrieving a root from a heap structure, an interpolation point having a minimum path distance may be extracted at high speed. That is, if N denotes the number of data, when deleting data of the root, data existing at the last address N is moved to the root. While data exchange between a parent and a child is performed in order to satisfy rule (3), parent-and-child address search is possible by multiplication or division by 2, whereby data exchange is performed in the order of log₂N. Accordingly, a high-speed search is possible. Such a technique is disclosed, for example, in Tetsuo Asano, “Data Structure”, (Kindai Kagaku sha Co., Ltd.), p. 30.

As illustrated in FIG. 20, the structure is arranged so that a heap address may be acquired for each interpolation point belonging to a front candidate point set. Even when a path distance is updated by adopting this structure, by directly referencing a heap address, heap path distances may be compared and transposed between a parent and child at high speed, thereby keeping the heap order relation normal. In addition, even if the address of the corresponding record in the front candidate point set table changes, correlation may be achieved by updating the address of the corresponding record in the front candidate point set table managed by the heap address. Accordingly, the extraction of an interpolation point that has a minimum path distance and is included in a front candidate point set is guaranteed.

Furthermore, the search processing unit 16 searches the front candidate point set for an interpolation point whose path distance is the shortest as an interpolation point existing on a front (step S9). In this process an interpolation point existing on a Huygens front (that is, an interpolation point that is a via point of the front) is identified. The interpolation point management table (FIG. 16) is searched and path distances are acquired with respect to an interpolation point registered in the front candidate point set table, and an interpolation point that has a shortest path distance among the acquired path distances is identified. When a heap structure is used, the processing as described above is necessary to be performed.

When this step is performed at first, since interpolation points on the path departure curve are registered as having a path distance of 0 in the interpolation point management table, any one of the interpolation points is selected.

In addition, distance correction by planar development, to be described later as an option, may be performed immediately after the step S9.

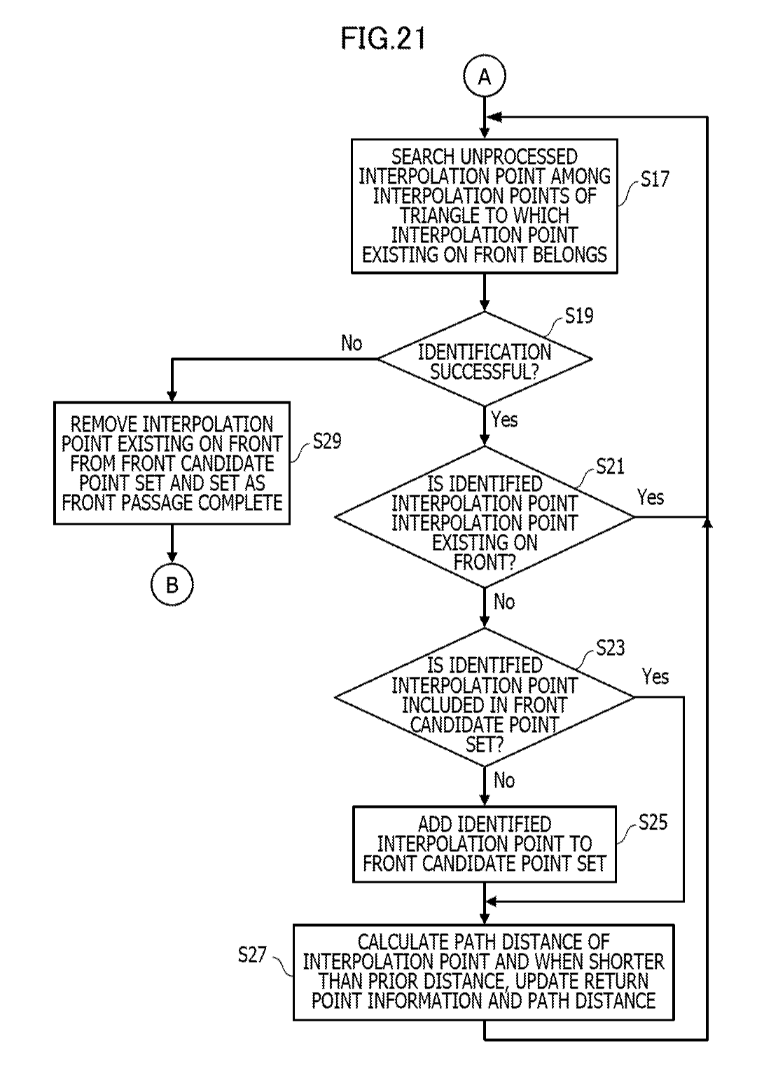

Subsequently, the search processing unit 16 determines whether or not the interpolation point existing on the front is on one of the path arrival curve stored in the start/end data storage unit 15 or, in other words, whether or not the interpolation point existing on the front is an interpolation point (or a vertex) included in the edge of a triangle associated with the one of the path arrival curve (step S11). If an interpolation point existing on the front does not exist on the path arrival curve, processing switches to the processing illustrated on FIG. 21 via terminal A.

On the other hand, if it is determined that an interpolation point existing on the front exists on the path arrival curve, the search processing unit 16 identifies the path distance with respect to the interpolation point existing on the front as a shortest distance and reads the return point information (return triangle, return edge, and return interpolation point) on the interpolation point existing on the front from the interpolation point management table, identifies an interpolation point on a shortest path by sequentially tracing return points such as reading a return point before the previous return point, and stores the shortest distance (e.g., creepage distance) and information on the interpolation point on the shortest path (ID and positional data) in the output data storage unit 18 (step S13). Moreover, shortest path correction processing by planar development, to be described later, may be performed in the present step.

The output unit 19 then outputs the shortest distance and the data on the interpolation point on the shortest path stored in the output data storage unit 18 to an output device such as a display device (step S15). For example, triangular mesh data of a three-dimensional model may be read from the triangular mesh data storage unit 11, whereby a diagram illustrating the shortest path (for example, FIG. 4) may be generated by connecting interpolation points on the shortest path on the triangular mesh, and may be displayed on the display device.

Next, processing subsequent to terminal A will be described with reference to FIG. 21 to FIG. 40. First, the search processing unit 16 searches for unprocessed interpolation points among interpolation points of a triangle to which the interpolation points existing on the front belong (FIG. 21: step S17). In the present step, only triangles that exist in a direction in which path distance increases are desirably searched, based on return point information belonging to the interpolation points existing on the front. Though processing may also be possible by setting all triangles as search objects of course, limited objects eliminates unnecessary searches and improves processing speed.

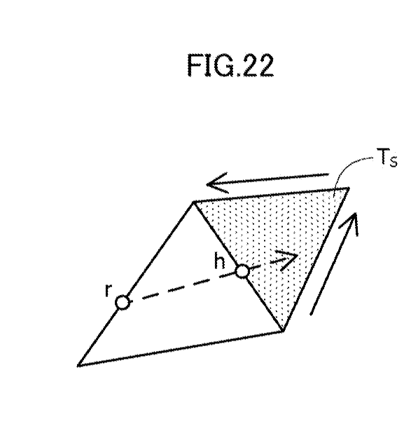

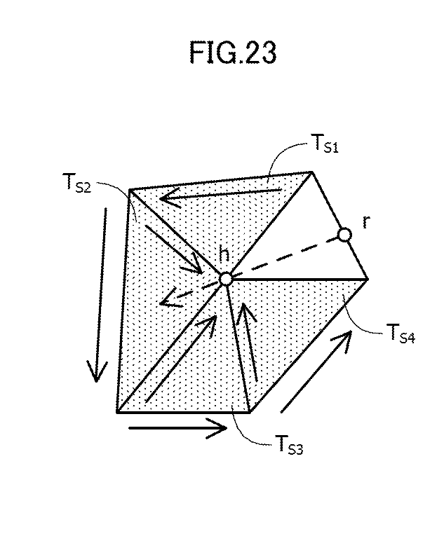

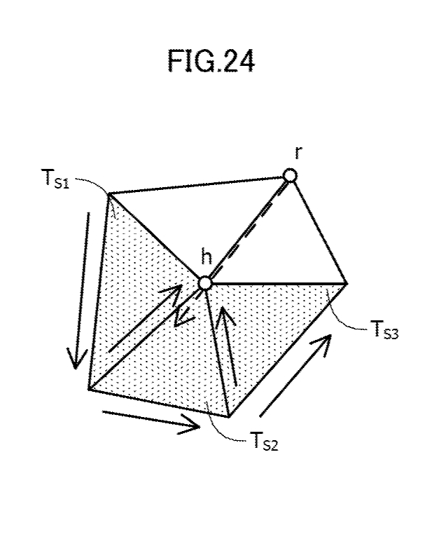

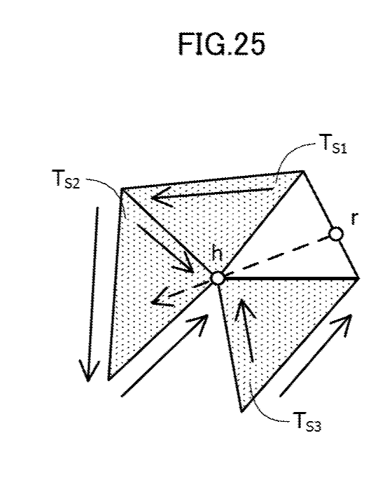

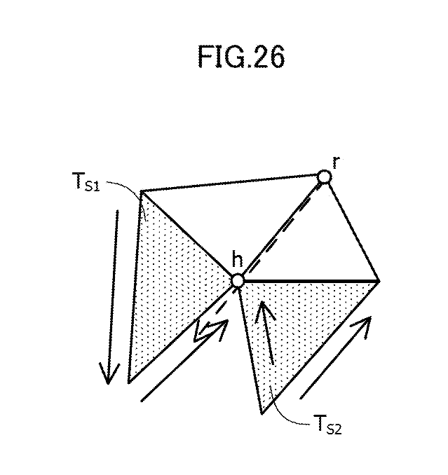

Specifically, as illustrated in FIG. 22, if an interpolation point h existing on a front exists on an edge of a triangle, interpolation points belonging to edges depicted by the solid arrows of a triangle Tₛ which shares an edge, on which the interpolation point h existing on the front exists, with a triangle to which a return point r and the interpolation point h existing on the front belong are set as search objects. On the other hand, as illustrated in FIGS. 23 to 27, various patterns exist if the interpolation point h existing on the front is a vertex of a triangle. As illustrated in FIG. 23, for example, if a vertex shared by five triangles is the interpolation point h existing on the front, interpolation points belonging to the respective edges of shared triangles Tₛ₁ to Tₛ₄ (the edges indicated by solid arrows, with the exception of edges shared by the triangle to which the return point r belongs) are set as search objects. In addition, as illustrated in FIG. 24, if the return point r and the interpolation point h existing on the front are vertices of a triangular mesh, a path is set along the edges of a triangular element, and the interpolation point h existing on the front is shared by two triangles sharing an edge on the path as well as, for example, three other triangles Tₛ₁ to Tₛ₃, then interpolation points belonging to the respective edges of the triangles Tₛ₁ to Tₛ₃ other than the triangles sharing the edge on the path (the edges indicated by solid arrows, with the exception of edges belonging to the triangles sharing the edge on the path), are set as search objects.

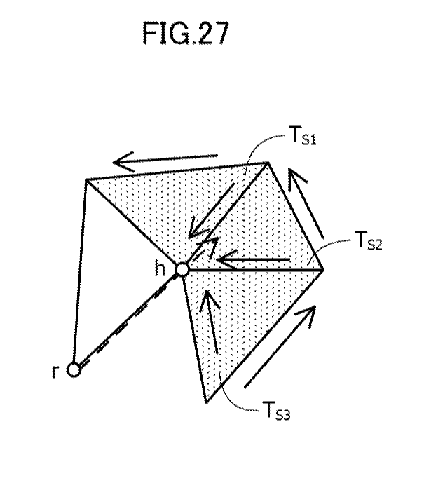

Furthermore, as illustrated in FIG. 25, even if the triangle to which the return point r and the interpolation point h existing on the front belong and the triangles Tₛ₁ to Tₛ₃ share the interpolation point h existing on the front but, unlike FIG. 23, triangles do not exist 360 degrees around the interpolation point h existing on the front, the same concept as FIG. 23 may be shared to set interpolation points belonging to the respective edges of the shared triangles Tₛ₁ to Tₛ₃ other than the triangles to which the return point r belongs (the edges indicated by solid arrows, with the exception of edges shared by the triangles to which the return point r belongs), are set as search objects. In addition, as illustrated in FIG. 26, even if the return point r and the interpolation point h existing on the front are vertices of a triangular mesh, a path is set along edges of a triangular element, the interpolation point h existing on the front is shared by triangles sharing an edge on the path as well as, for example, triangles Tₛ₁ and Tₛ₂ but, unlike FIG. 24 triangles do not exist 360 degrees around the interpolation point h existing on front, the same concept as FIG. 24 may be shared to set interpolation points belonging to the respective edges of the triangles Tₛ₁ and Tₛ₂ (the edges indicated by solid arrows, with the exception of edges belonging to the triangles sharing the edge on the path) as search objects.

FIG. 27 illustrates a case where a path extends from the return point r to the interpolation point h existing on the front along a boundary of an area in which a triangular mesh is not formed, and a plurality of triangles share the interpolation point h existing on the front that is a vertex. In such a case, interpolation points belonging to the respective edges of triangles Tₛ₁ to Tₛ₃ sharing the interpolation point h existing on the front other than the triangles to which the edges on the path (the edges indicated by solid arrows, with the exception of edges shared by the triangle including the return point r) belong are set as search objects.

In the present embodiment, mesh structure topological information is used to identify such search objects as described above. Specifically, using a topological table such as that illustrated in FIG. 10 adjacent triangular elements incident to an edge can be identified. Furthermore, vertices of a triangle may be identified by using the triangle table illustrated in FIG. 9. Association of vertices and edges may be realized by adopting a rule requiring, for example, numbers to be assigned counter-clockwise. If triangles and edges may be identified, then interpolation points may also be identified using an interpolation point management table. As shown, since a search object may be known using topological information, pointers indicating a connection destination need not be retained in a graph structure used in Dijkstra's algorithm or the like. Accordingly, the data volume may be reduced by that amount.

A search destination triangle is identified under a policy such as any of those illustrated in FIGS. 23 to 27, whereby an unprocessed interpolation point is searched for among the search destination triangles. In doing so, if all corresponding interpolation points have been processed and there are no unprocessed interpolation points (step S19: No), the search processing unit 16 removes the interpolation point h existing on the front from the front candidate point set (e.g., the front candidate point set table) and updates the interpolation point attribute of the interpolation point h existing on the front in the interpolation point management table (FIG. 16) to “front passage complete” (step S29). Since the Huygens front may be assumed to have been passed in this manner, the Huygens front may be excluded from subsequent processing. Processing returns to step S9 illustrated in FIG. 13 via terminal B.

On the other hand, if a search destination triangle is identified and an unprocessed interpolation point exists in the search destination triangle (step S19: Yes), the search processing unit 16 determines, based on the interpolation point management table (FIG. 16), whether the identified interpolation point is an interpolation point whose interpolation point attribute is “front passage complete” (step S21). If the identified interpolation point is an interpolation point whose interpolation point attribute is “front passage complete”, the processing returns to step S17.

On the other hand, if the identified interpolation point is not an interpolation point whose interpolation point attribute is “front passage complete”, the search processing unit 16 determines whether or not the identified interpolation point belongs to a front candidate point set or, in other words, whether the identified interpolation point is registered to a front candidate point set table (step S23). If registered, since there is no need to re-register, the processing proceeds to step S27. On the other hand, if not registered, the identified interpolation point is added as a front candidate point set or, in other words, registered in a front candidate point set table (step S25). The interpolation point attribute in the interpolation point management table is also changed to “front candidate”. This is performed in order to set the identified interpolation point as a source candidate of subsequent search processing.

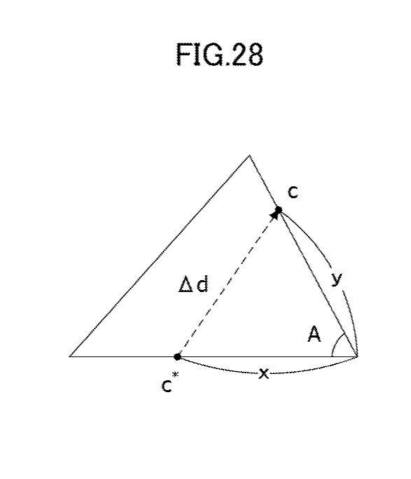

If it is determined after step S25 or in step S23 that the identified interpolation point has already been registered in the front candidate point set table, the search processing unit 16 calculates a path distance from the path departure curve to the identified interpolation point. As illustrated in FIG. 28, first, an inter-triangle distance Δd from an interpolation point existing on a front c* having a path distance of d* to a searched interpolation point (front candidate point) c is calculated. The inter-triangle distance Δd is calculated as the distance between coordinates of the interpolation point existing on the front c* and the interpolation point c. Subsequently, the path distance of the interpolation point (front candidate point) may be obtained by adding the path distance d* of the interpolation point existing on front c* to the inter-triangle distance Δd.

Moreover, when a cosine table or an edge length table is prepared as described earlier, the inter-triangle distance Δd may be calculated at high speed using the cosine theorem. That is, the inter-triangle distance Δd may be calculated using the following equation.

Δd=\sqrt{x²+y²−2 cos A·xy} [Expression 1]

A calculation using the above equation requires less amount of calculation than interior division of vertex coordinates on both ends of an edge to which the interpolation point belongs and calculating a square root of a sum of squares of coordinate elements of two interpolation points.

Moreover, when interpolation point coordinates are to be calculated in advance as illustrated in FIG. 15, a distance may be calculated using such values.

Furthermore, when refractive index is provided in a triangular element, the inter-triangle distance Δd is corrected by multiplying the inter-triangle distance Δd by a coefficient determined based on the refractive index of a corresponding triangular element.

Subsequently, a determination is made on whether the just calculated path distance (d*+Δd) is shorter than the current path distance of the identified interpolation point (front candidate point). If so, the path distance of the identified interpolation point in the interpolation point management table is replaced by the path distance just calculated and return point information is replaced by a triangle ID, an edge ID, and an interpolation point ID of the current interpolation point existing on the front (step S27). Here, a shortest distance of a shortest path at the time of processing and information on the last interpolation point on the path are registered for the identified interpolation point.

When managing the path distance of a front candidate point using a heap structure, inter-node exchange is formed so as to avoid occurrences of discrepancies in the heap structure. In addition, synchronization is preferably performed when a plurality of interpolation points that are the same in substance exist under different identifiers in the interpolation point management table.

The processing returns to step S17 to repeat the processes described above.

By performing the processes described above, when the interpolation point existing on the front identified in step S9 of FIG. 13 reaches an interpolation point on the path arrival curve, the shortest distance is readily identified because the shortest distance is registered with respect to the path distance at a corresponding interpolation point existing on the front. Since return point information is managed in the interpolation point management table, a shortest path may also be readily identified by tracing the return point information.

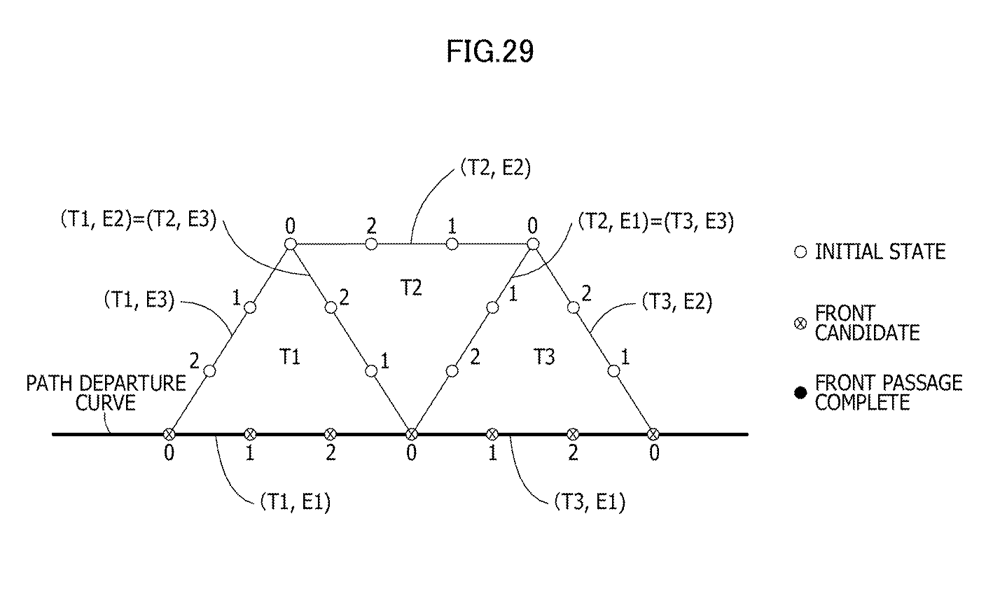

Hereinafter, a specific processing example will be presented with reference to FIGS. 29 to 40 to explain the processing described above in an easily comprehensible manner. For example, assume a triangular mesh such as that illustrated in FIG. 29 in which two interpolation points are set to each edge and which includes triangular elements T1 to T3. In FIG. 29, the bold line indicates a path departure curve. The triangle T1 includes edges (T1, E1), (T1, E2) (=(T2, E3)), and (T1, E3); the triangle T2 includes edges (T2, E1) (=(T3, E3)), (T2, E2), and (T2, E3) (=(T1, E2); and the triangle T3 includes edges (T3, E1), (T3, E2), and (T3, E3) (=(T2, E1)). Identification numbers are assigned to interpolation points counter-clockwise.

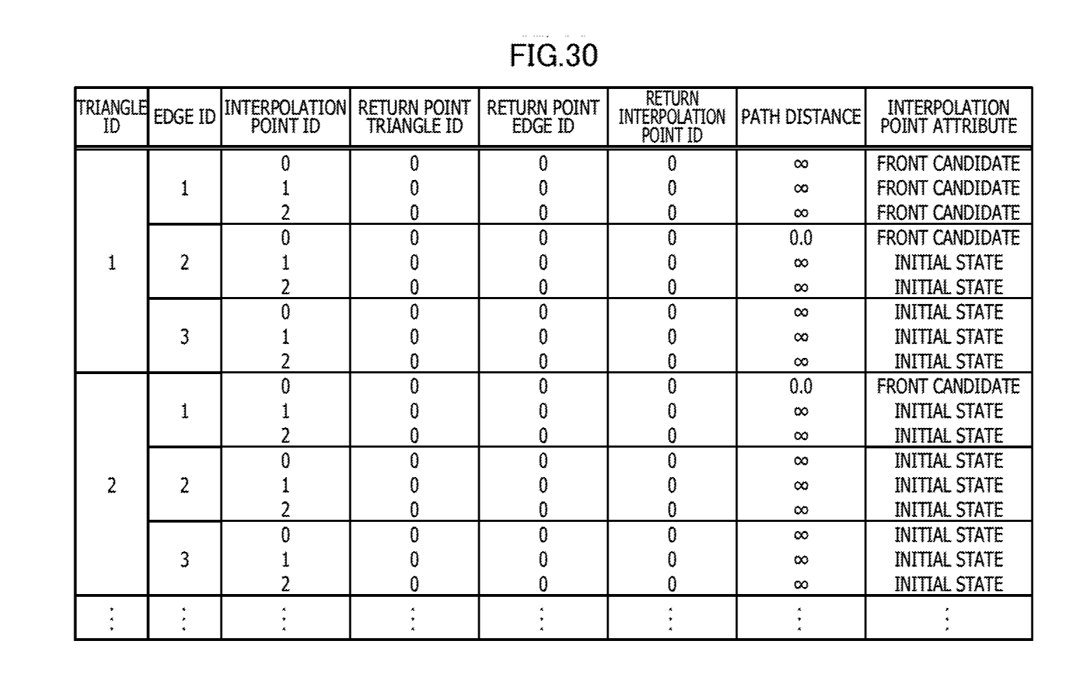

When such a triangular mesh exists, an interpolation point management table assumes a state such as that illustrated in FIG. 30. Since a search is yet to be performed, return point information of all interpolation points is “0”. In addition, while the path distance of all interpolation points are initially infinite, since a path departure curve has already been specified, a path distance of “0” has been registered for interpolation points on the path departure curve (the interpolation point on edges (T1, E1) and (T3, E1)). In a similar manner, since interpolation points on the path departure curve are registered in step S7 as front candidate points in a front candidate point set, the interpolation point attributes of the interpolation points on the path departure curve are changed from an initial state to a front candidate state.

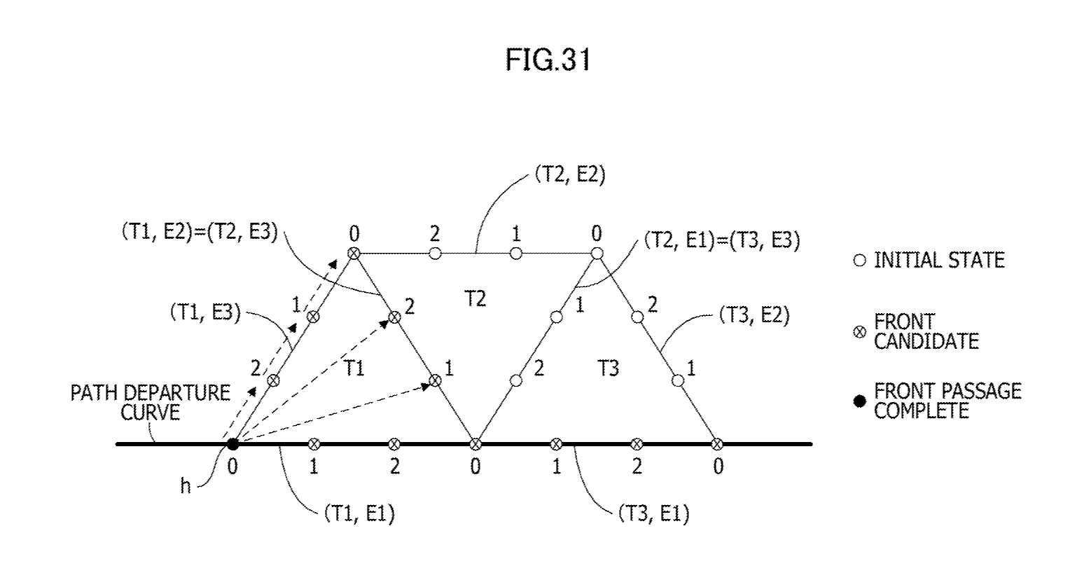

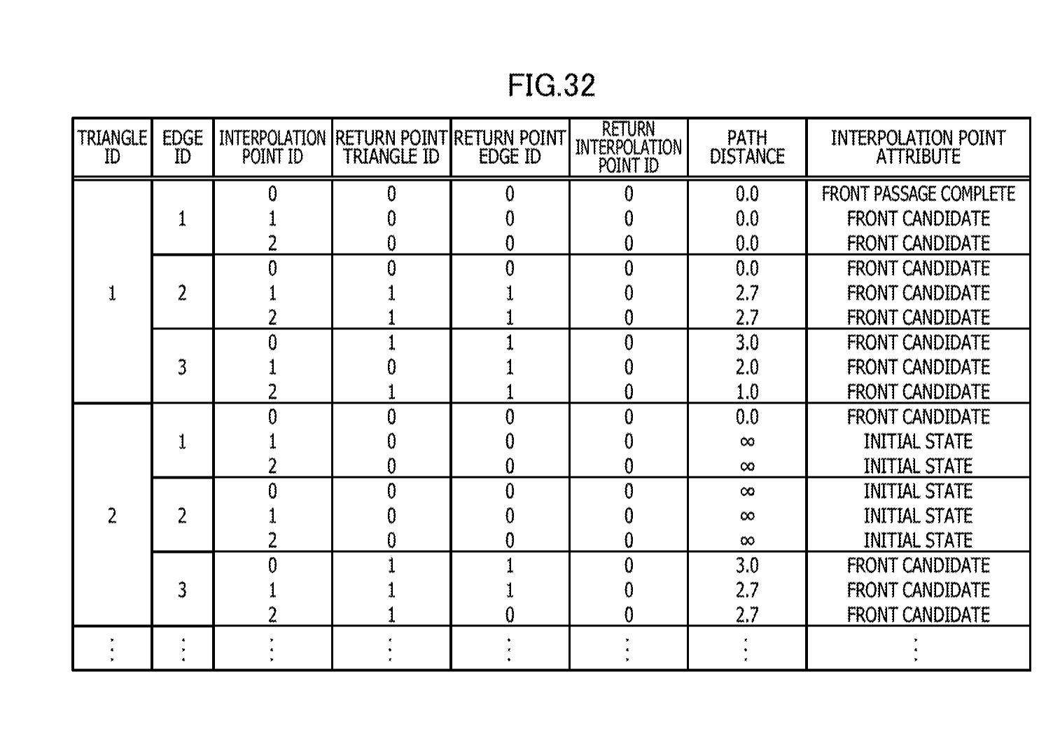

Next, a case where a vertex on the left end of the edge (T1, E1) is selected as an interpolation point h existing on the front will be described with reference to FIGS. 31 and 32. In this case, as indicated by the dotted arrow in FIG. 31, the edges (T1, E3) and (T1, E2) of the triangle T1 are identified as search object edges and the five interpolation points on the edges are sequentially specified. As a result, the interpolation point management table changes from the state illustrated in FIG. 30 to the state illustrated in FIG. 32. In FIG. 32, when represented by a combination of (triangle ID, edge ID, interpolation point ID), for interpolation points (1, 2, 1), (1, 2, 2), (1, 3, 0), (1, 3, 1), and (1, 3, 2), (1, 1, 0) is registered as return point information, respective path distances are registered, and the interpolation point attribute is changed to “front candidate state”. The triangle T2 is updated to synchronize the state of the identical interpolation points.

Finally, the interpolation point attribute of the interpolation point (1, 1, 0) that is the interpolation point h existing on the front is changed to “front passage complete”.

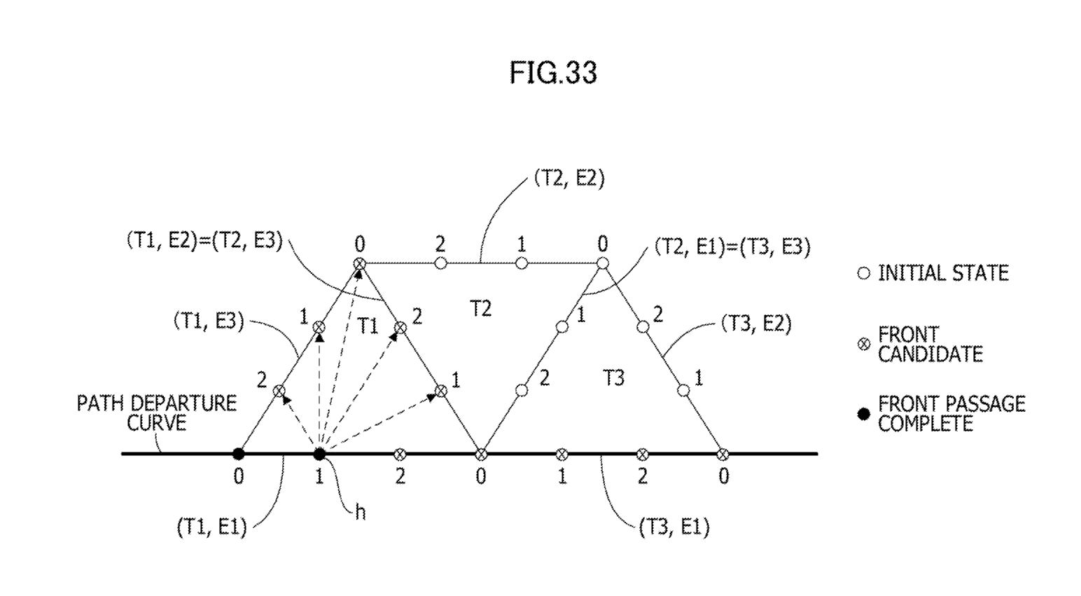

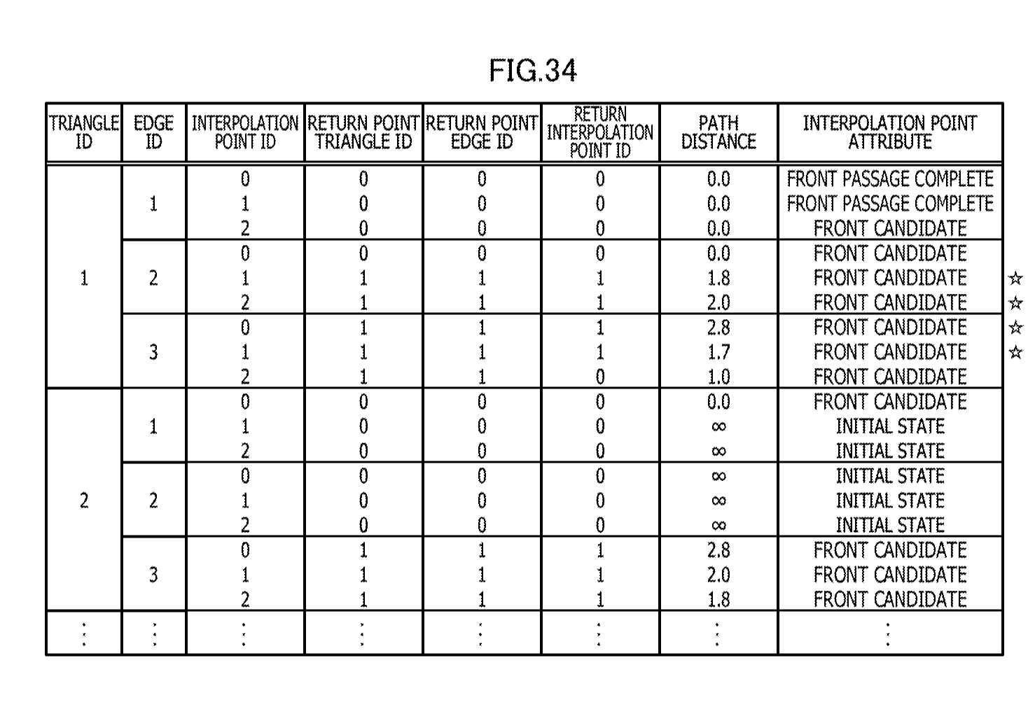

Subsequently, the interpolation point (1, 1, 1) having the shortest path distance among the interpolation points whose interpolation point attribute is “front candidate” is selected as the interpolation point h existing on the front. In this case, as indicated by the dotted arrows in FIG. 33, the edges (T1, E3) and (T1, E2) of the triangle T1 are identified as search object edges and the five interpolation points on the edges are sequentially specified. As a result, the interpolation point management table changes from the state illustrated in FIG. 32 to the state illustrated in FIG. 34. That is, a calculation of path distances of the interpolation points (1, 2, 1), (1, 2, 2), (1, 3, 0), (1, 3, 1), and (1, 3, 2) from the interpolation point (1, 1, 1) reveals that the path distances of interpolation points other than the interpolation point (1, 3, 2), namely, (1, 2, 1), (1, 2, 2), (1, 3, 0), and (1, 3, 1), have been shortened. Therefore, for such interpolation points (the lines indicated by stars in FIG. 34), path distances are changed to the currently calculated values. Thereafter, return point information thereof is changed to interpolation point information (1, 1, 1) of the interpolation point h existing on the front. Since the interpolation point attribute of the search target interpolation point has already been changed to “front candidate”, no further change is made at this time.

Here, the triangle T2 is updated to synchronize the state of the identical interpolation points.

Finally, the interpolation point attribute of the interpolation point (1, 1, 1) that is the interpolation point h existing on the front is changed to “front passage complete”.

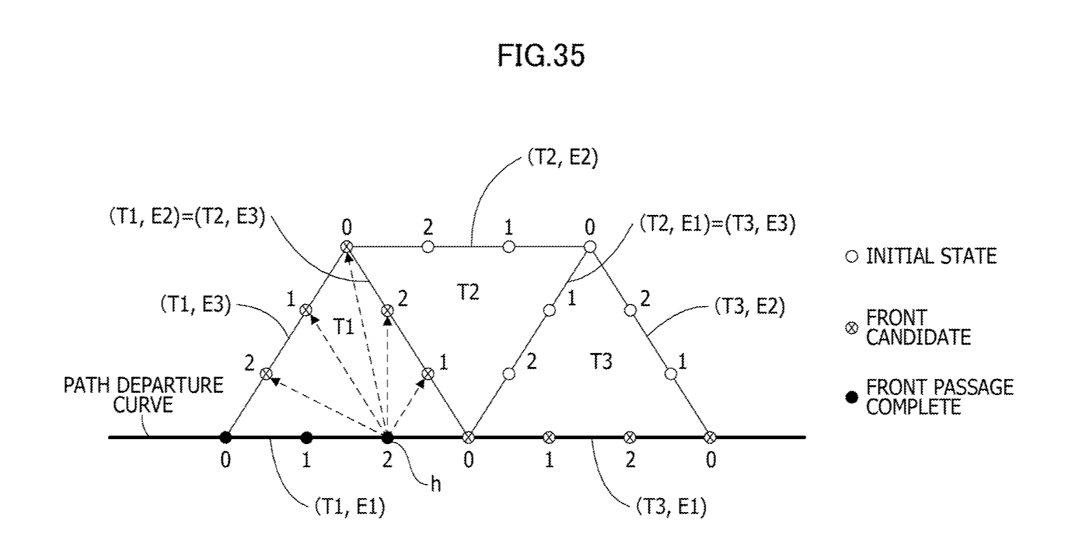

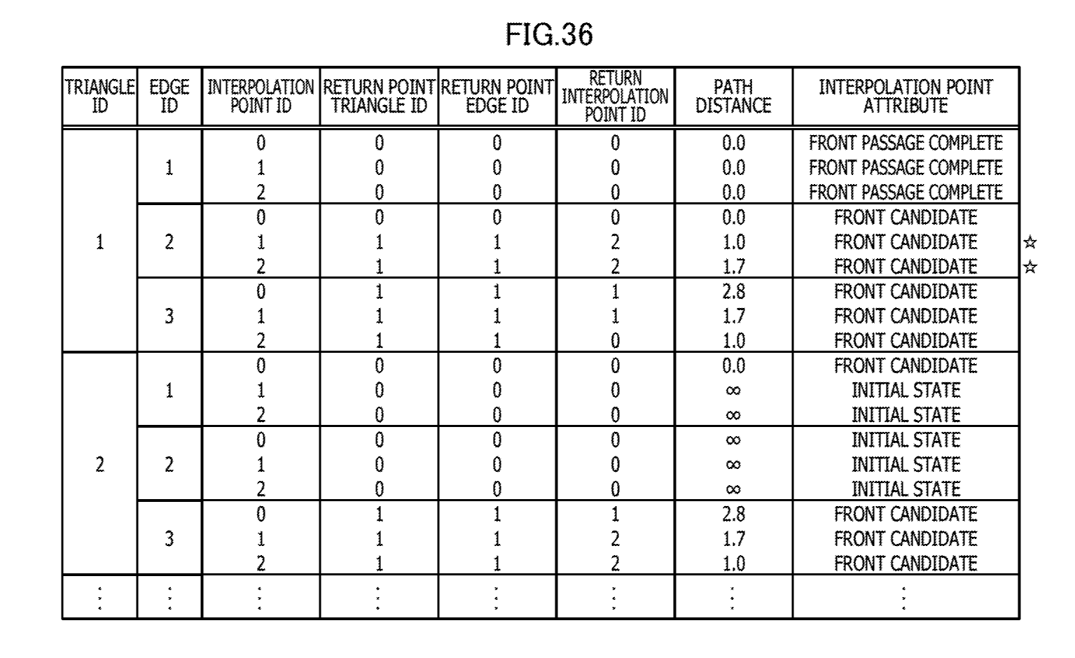

Furthermore, an interpolation point (1, 1, 2) having the shortest path distance among the interpolation points whose interpolation point attribute is “front candidate” is selected as the interpolation point h existing on the front. In this case, as indicated by the dotted arrows in FIG. 35, the edges (T1, E3) and (T1, E2) of the triangle T1 are identified as search object edges and the five interpolation points on the edges are sequentially specified. As a result, the interpolation point management table changes from the state illustrated in FIG. 34 to the state illustrated in FIG. 36. That is, a calculation of path distances of the interpolation points (1, 2, 1), (1, 2, 2), (1, 3, 0), (1, 3, 1), and (1, 3, 2) from the interpolation point (1, 1, 2) reveals that the path distances of interpolation points (1, 2, 1) and (1, 2, 2) have been shortened. Therefore, for such interpolation points (the lines indicated by stars in FIG. 36), path distances are changed to the currently calculated values. Thereafter, return point information thereof is changed to interpolation point information (1, 1, 2) of the interpolation point h existing on the front. Since the interpolation point attribute of the searched interpolation point has already been changed to “front candidate”, no further change is made at this time.

Here, the triangle T2 is updated to synchronize the state of the identical interpolation points.

Finally, the interpolation point attribute of the interpolation point (1, 1, 2) that is the interpolation point h existing on the front is changed to “front passage complete”.

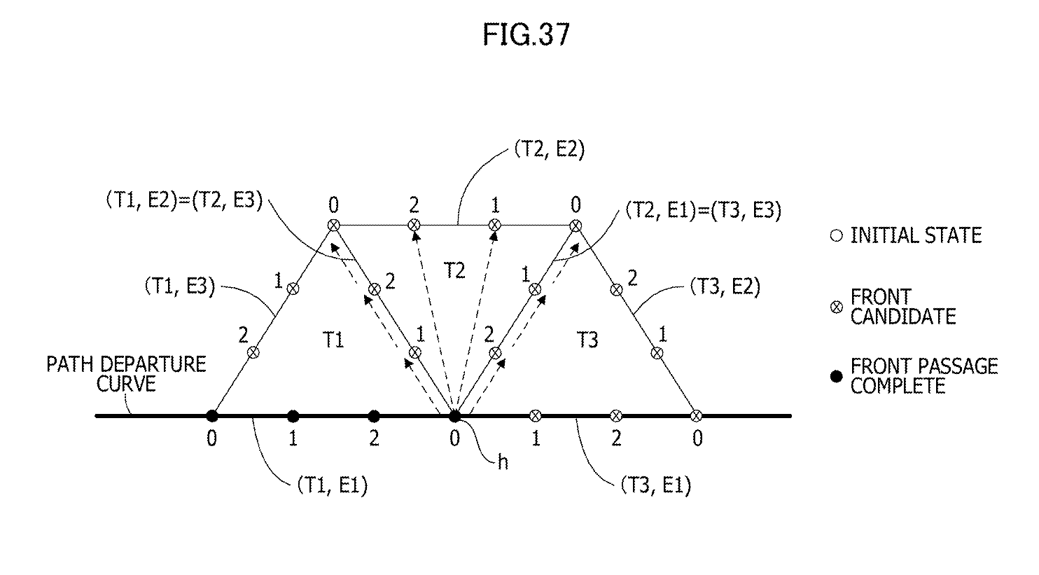

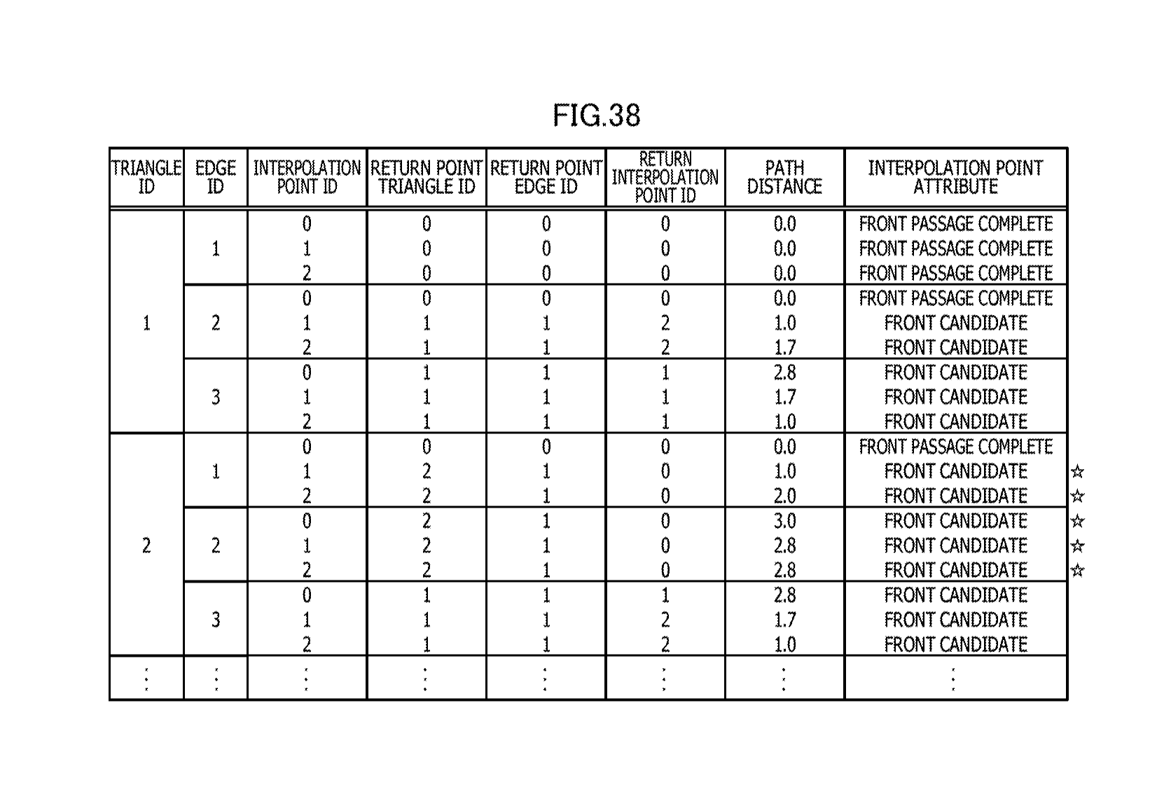

Subsequently, an interpolation point (2, 1, 0) (=(1, 2, 0)) having the shortest path distance among the interpolation points whose interpolation point attribute is “front candidate” is selected as the interpolation point h existing on the front. In this case, as indicated by the dotted arrows in FIG. 37, the edges (T2, E3), (T2, E2), and (T2, E1) of the triangle T2 are identified as search object edges and the eight interpolation points on the edges are sequentially specified. As a result, the interpolation point management table changes from the state illustrated in FIG. 36 to the state illustrated in FIG. 38. That is, a calculation of path distances of the interpolation points (2, 1, 1), (2, 1, 2), (2, 2, 0) (2, 2, 1), (2, 2, 2), (2, 3, 0), (2, 3, 1), and (2, 3, 2) from the interpolation point (2, 1, 0) reveals that the path distances of interpolation points (2, 1, 1), (2, 1, 2), (2, 2, 0) (2, 2, 1), and (2, 2, 2) have been shortened. Therefore, for such interpolation points (the lines indicated by stars in FIG. 38), path distances are changed to the currently calculated values. Thereafter, return point information thereof is changed to interpolation point information (2, 1, 0) of the interpolation point h existing on the front. Moreover, the interpolation point attributes of the interpolation points have been changed to “front candidate”.

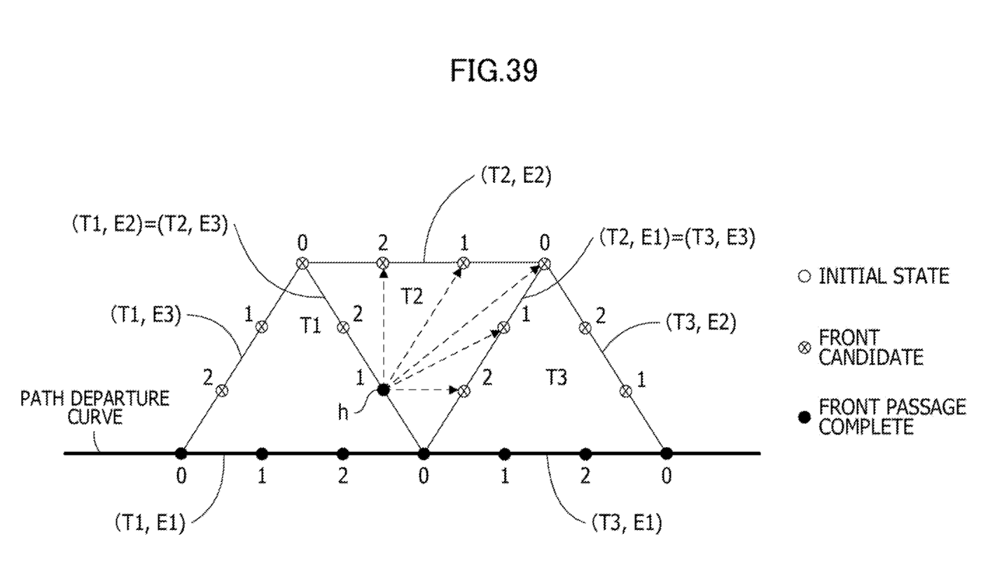

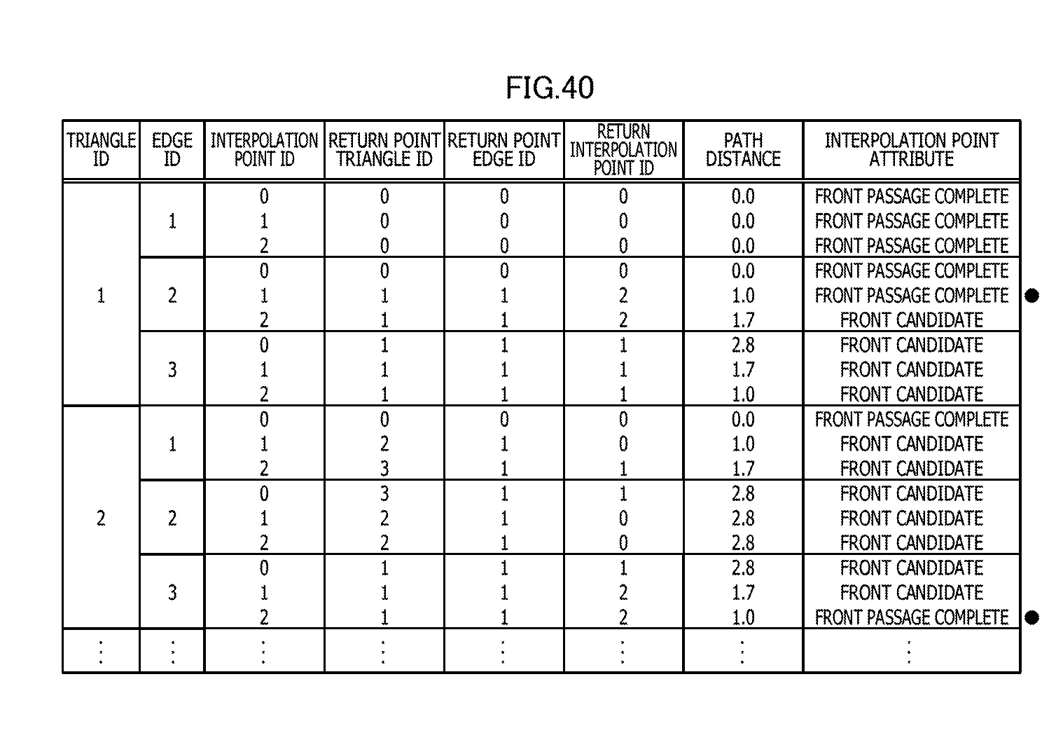

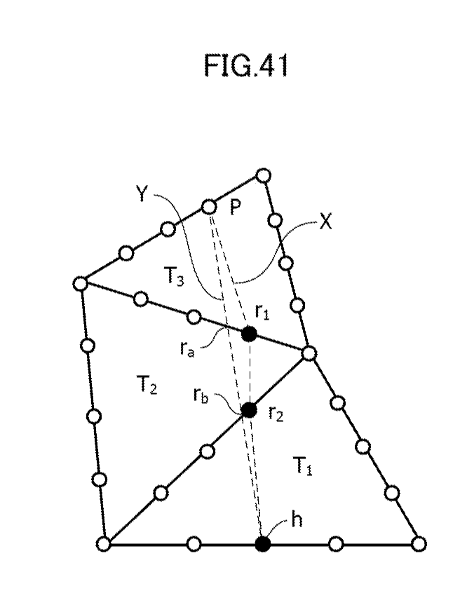

After repeatedly performing such processing, once search processing on the interpolation points on the path departure line is completed and the interpolation points have been removed from the front candidate point set, the front candidate point with the shortest path distance is now the interpolation point (1, 2, 1) (=(2, 3, 2)). This interpolation point (1, 2, 1) is selected as the interpolation point h existing on the front. In this case, as indicated by the dotted arrows in FIG. 39, the edges (T2, E1) and (T2, E2) of the triangle T2 are identified as search object edges and the five interpolation points on the edges are sequentially specified. As a result, the interpolation point management table changes from the state illustrated in FIG. 38 to the state illustrated in FIG. 40. That is, a calculation of path distances of the interpolation points (2, 1, 1), (2, 1, 2), (2, 2, 0), (2, 2, 1), and (2, 2, 2) from the interpolation point (1, 2, 1) reveals that the path distances remain unchanged for all interpolation points. Therefore, there are no interpolation points for which the path distance is updated. The return point information and interpolation point attributes are not updated. However, the interpolation point attribute of the interpolation point (1, 2, 1) (=(2, 3, 2)) is changed to “front passage complete”.

Interpolation points are introduced to triangular elements of the triangular mesh by repeatedly performing the above processing. Since searches are performed without generating arcs between interpolation points, the data volume is reduced and processing speed is increased.

Indeed the method described above is feasible, but shortest distance calculation allows further refinement. As illustrated in FIG. 41, when arriving from an interpolation point p on a path at an interpolation point h existing on the front via interpolation points r₁ and r₂, assume that the triangles T₁ to T₃ to which the interpolation points belong may be developed into a plane to which the triangle T₁ belongs. In this case, when going through preset interpolation points r₁ and r₂, a path X from the interpolation point p to the interpolation point h existing on the front ends up being longer than a linear distance Y from the interpolation point p to the interpolation point h existing on the front. Therefore, register a path distance for the interpolation point h existing on the front, and the more accurate path distance may be obtained by, for example, using a linear distance of a path Y rather than the path X.

The calculation of path distances by planar development as well as positional correction of interpolation points to be adopted when calculating path distances by planar development (in other words, in FIG. 41, changes from r₁ to rₐ and from r2 to r_{b}) are realized by processing described below.

A. Planar Development Path Distance Correction Processing

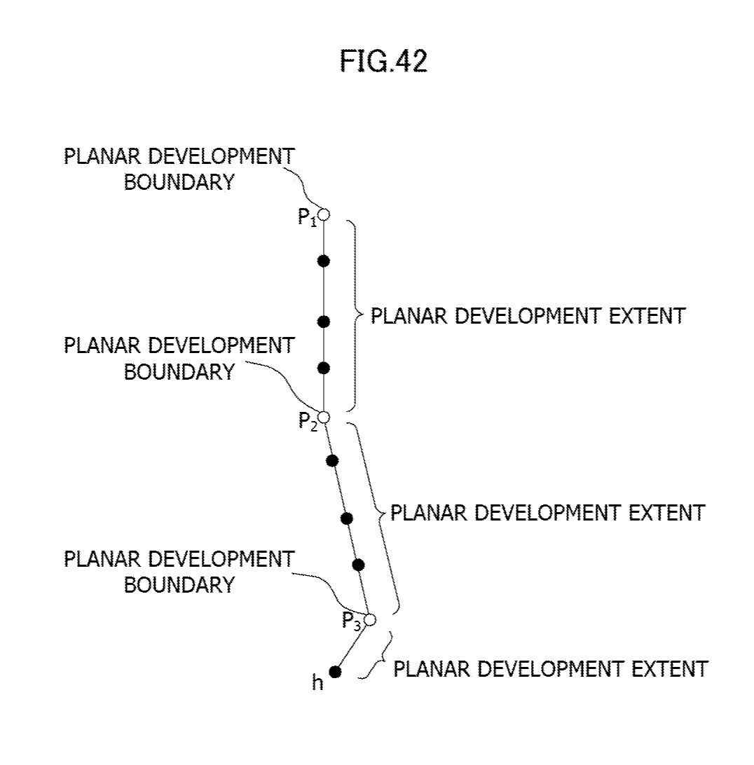

The present processing will be described with reference to FIGS. 42 to 49. The present processing is performed each time an interpolation point existing on a front is identified in step S9.

Before providing a specific description of the processing, a planar development extent and a planar development boundary will be described. As described above, while it is desirable to develop triangular elements on a path in a triangular mesh into planes and connect the interpolation points by straight lines, not all triangular elements on a path are able to be developed into planes and, in some case, it is more preferable not to perform planar development. Therefore, when detecting an interpolation point (including a vertex) that satisfies the conditions described below, it is assumed that planar development is to be performed up to the interpolation point or to an immediately preceding interpolation point, whereby the interpolation point is to be referred to as a planar development boundary. As illustrated in FIG. 42, a range between adjacent planar development boundaries on a path (for example, between P₁ and P₂ and between P₂ and P₃) as well as a range between the interpolation point h existing on the front and the immediately preceding planar development boundary P₃ on the path will be referred to as planar development extent. The planar development extent between the interpolation point h existing on the front and the planar development boundary P₃ is extended until the next planar development boundary is detected.

There are two sets of conditions in which a planar development boundary is identified. Condition A is as follows:

(1) when a newly progressed interpolation point existing on a front reaches a vertex of a triangle;

(2) when a state exists in which a line segment from a newly progressed interpolation point existing on a front to a planar development boundary no longer intersects all edges; or

(3) when the number of interpolation points making up a planar development extent no longer satisfies a preset condition.

A planar development boundary is determined when any of the three conditions is satisfied.

On the other hand, condition B is as follows.

(1) When a state exists in which a line segment from a newly progressed interpolation point existing on a front to a planar development boundary no longer intersects all edges; or

(2) when the number of interpolation points making up a planar development extent no longer satisfies a preset condition.

A planar development boundary is determined if any one of the two conditions is satisfied.

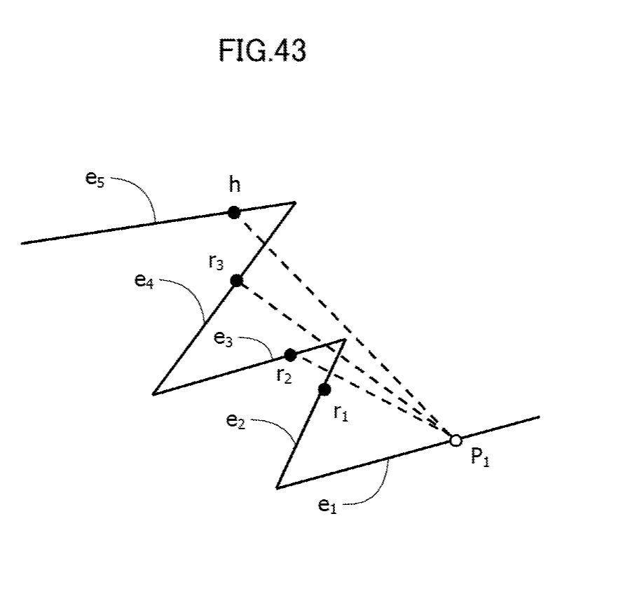

The condition A(2) and the condition B(1) represent a status such as that illustrated in, for example, FIG. 43. In the following description, it is assumed that edges and interpolation points have already been developed on a single plane. FIG. 43 assumes a case in which a planar development boundary P₁ belongs on an edge e₁, an interpolation point r₁ on a path belongs on an edge e₂, an interpolation point r₂ on the path belongs on an edge e₃, an interpolation point r₃ on the path belongs on an edge e₄, and an interpolation point h on the path or, in other words, the interpolation point h existing on the front belongs on an edge e₅. In this case, the interpolation point r₁ and the planar development boundary P₁ are mutually adjacent interpolation points on a path, and therefore inevitably unable to satisfy the condition A(2) and the condition B(1). Thus they are excluded from the determination. However, since a line segment connecting the interpolation point r₂ and the planar development boundary P₁ intersects with the edge e₂, and a line segment connecting the interpolation point r₃ and the planar development boundary P₁ intersects with the edge e₂ and the edge e₃, conditions A(2) and B(1) are not satisfied. However, since a line segment connecting the interpolation point h existing on the front and the planar development boundary P₁ intersects with the edge e₄ but not the edges e₃ and e₂, conditions A(2) and B(1) are satisfied. As long as an interpolation point h existing on a front is identified within a certain range as seen from the planar development boundary P₁ to extend the path in this manner, no problems will arise. However, as the case illustrated in FIG. 43, if a curved path is connected by straight lines, a problem arises in that the midway interpolation points r₁, r₂, and r₃ may no longer be defined on the same edge and a return point may not be properly provided. In other words, a straight line connecting two points will not form a shortest path. From this, when an interpolation point h existing on the front that does not satisfy the conditions A(2) and B(1) is detected, the immediately preceding interpolation point r₃ on the path (a return point of the interpolation point h existing on the front) is identified as the planar development boundary.

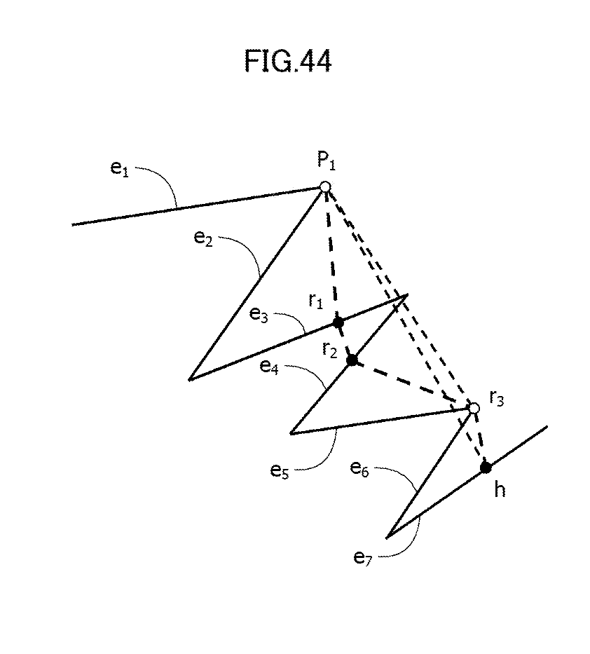

In case of the condition A(1) when a straight line connecting two points does not form a shortest path, an interpolation point thereof is identified as the planar development boundary. However, since there are some cases where the interpolation point is not necessarily a characteristic point and therefore planar development does not cause a problem, the interpolation point is not adopted in the condition B. For example, as illustrated in FIG. 44, when planar development is performed from the planar development boundary P₁ to the interpolation point h existing on the front, assume that the vertex shared by the edge e₁ and the edge e₂ is the planar development boundary P₁, a next interpolation point r₁ on the path exists on the edge e₃, a next interpolation point r₂ on the path exists on the edge e₄, the intersection of the edges e₅ and e₆ is a vertex r₃ on the path, and the interpolation point h existing on the front on the path exists on a path e₇. In this case, when adopting the condition A, the vertex r₃ is identified as the planar development boundary. However, a line segment connecting the vertex r₃ and the planar development boundary P₁ intersects the midway edges e₃ and e₄. In other words, interpolation points may be defined even at midway edges to identify a return point. Therefore, when adopting the condition B and not terminating the planar development extent at the vertex r₃, since the line segment connecting the interpolation point h existing on the front and the planar development boundary P₁ intersects midway edges, the planar development extent may be extended to the interpolation point h existing on the front. As a result, since the length over which a linear distance may be calculated is extended, the accuracy of the path distance may be improved. However, depending on the shape of the three-dimensional model, the same may also become necessary for the condition A(1).

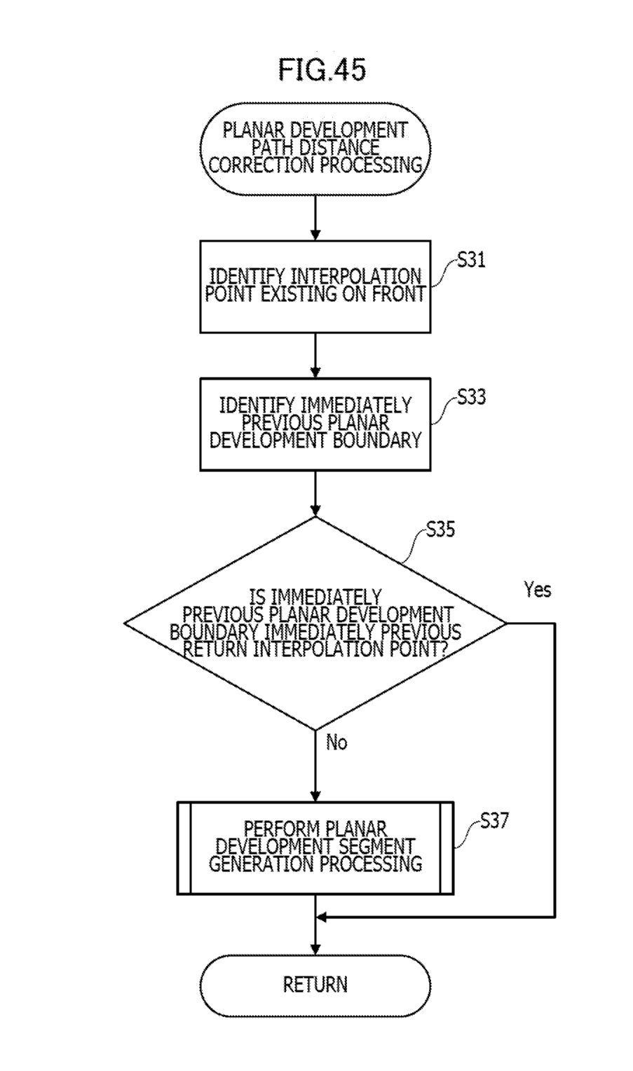

Based on the premises presented above, specific processing contents will be described with reference to FIGS. 45 to 49.

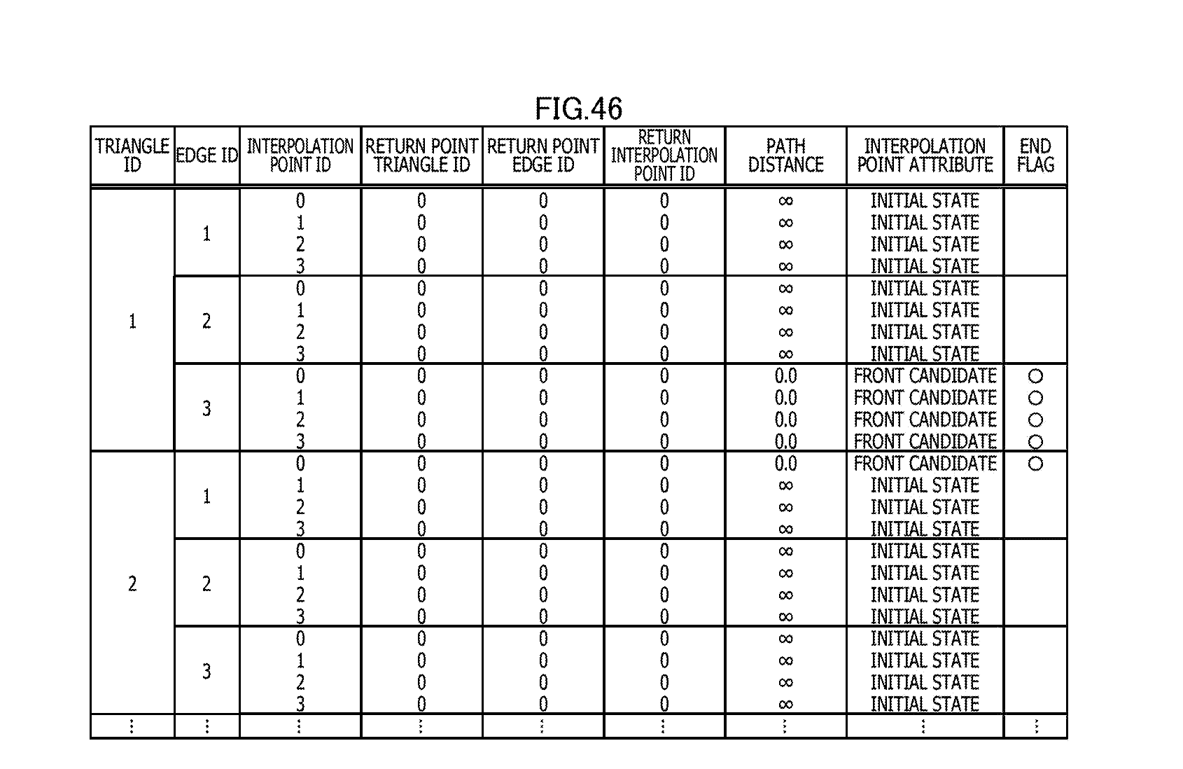

First, the distance compensation unit 161 identifies an interpolation point existing on a front (FIG. 45: step S31). This step is the same as step S9. An immediately preceding planar development boundary is then identified (step S33). For example, the data format of the interpolation point management table illustrated in FIG. 16 is transformed to the data format illustrated in FIG. 46. In other words, a column of end flags that are flags indicating whether an interpolation point is a planar development boundary or not is added in the table in FIG. 16. An end flag is set when it is determined in the processing described below that an interpolation point is a planar development boundary, and is initially set for interpolation points on the path departure curve. FIG. 46 illustrates a state where initial setting has been completed.

The distance compensation unit 161 determines whether an immediately preceding planar development boundary is an immediately preceding return interpolation point of an interpolation point existing on a front (step S35). If this condition is satisfied, no processing is required, since the interpolation point existing on the front and the planar development boundary are connected linearly. As such, processing returns to the original processing if this condition is satisfied. On the other hand, if this condition is not satisfied, planar development extent generation processing is performed (step S37). This processing will be described in detail below. Subsequently, processing returns to the original processing.

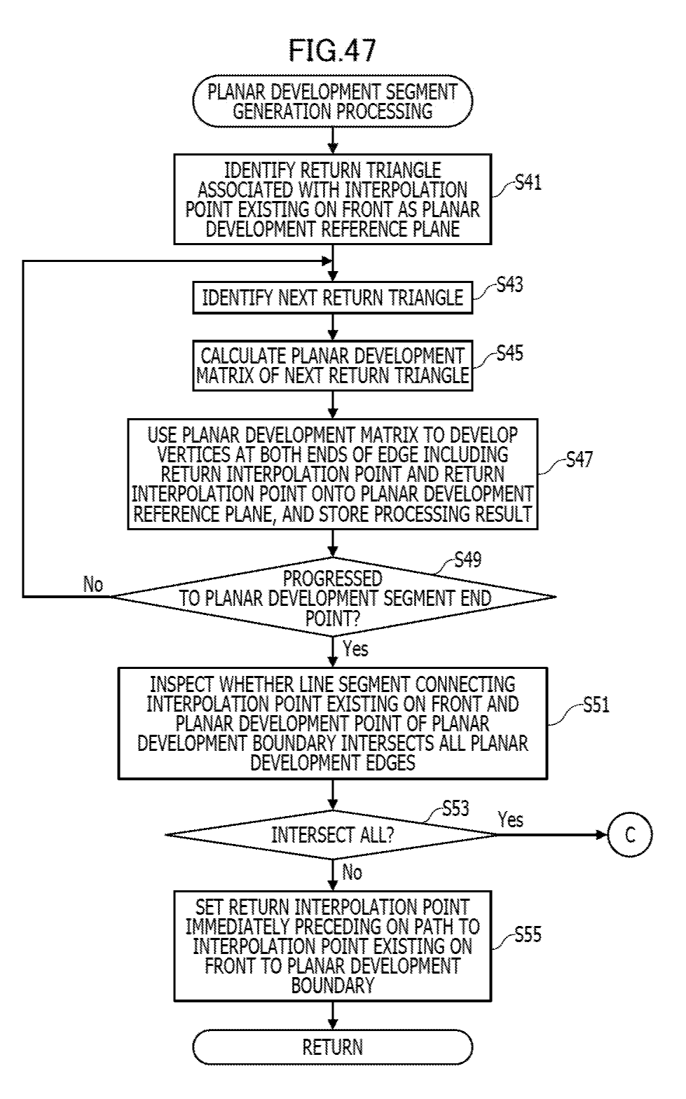

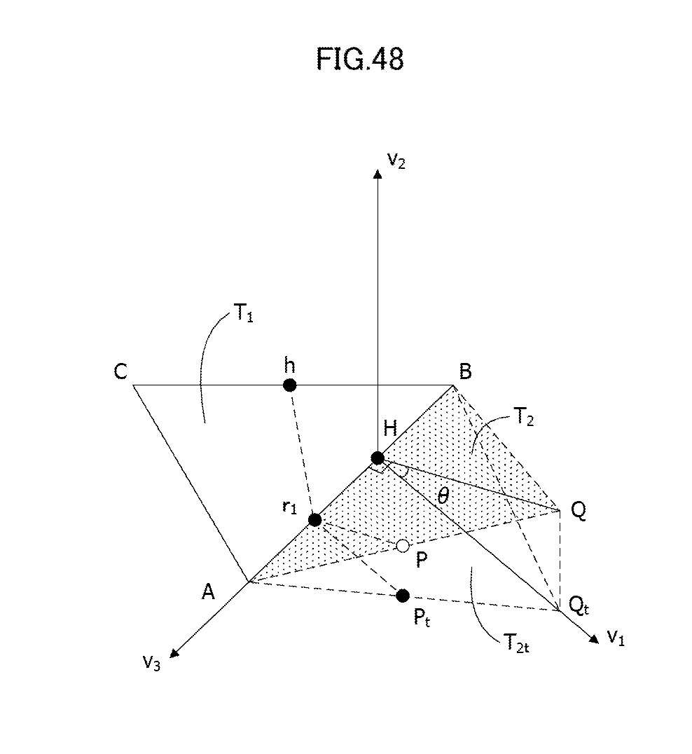

Next, planar development extent generation processing will be described with reference to FIGS. 47 to 49. First, the distance compensation unit 161 identifies a return triangle associated with an interpolation point existing on a front as a planar development reference plane (step S41). For example, assume a condition such as that illustrated in FIG. 48. A return triangle T₁ (vertices ABC) including the interpolation point h existing on the front and the immediately preceding interpolation point r₁ on the path is identified as a planar development reference plane. The return triangle T₁ is registered in the interpolation point management table (FIG. 46) as return point information. Subsequently, a next return triangle is identified (step S43). In the example illustrated in FIG. 48, a triangle T₂ (vertices AQB) is identified. Thereafter, a planar development matrix of the next return triangle T₂ is calculated and stored in, for example, the processing data storage unit 17 (step S45). A method of calculating a planar development matrix of a next return triangle will be described. First, let point H denote a foot of a perpendicular line from a vertex Q of the next return triangle T₂ to an edge AB. If v₁ denotes a unit vector from the point H to a projection point Qt of the vertex Q to the planar development reference plane, and v₃ denotes a unit vector from the point H to the vertex A, then v₂=v₃×v₁, where “×” means a vector product operation. Let θ denote a v₂-direction angle formed by a vector HQ and the unit vector v₁. Then, the following matrix is defined.

$$\begin{matrix}M = ( {v}_{1} , {v}_{2} , {v}_{3} ) & [ Expression 2 ] \\ R = ( \begin{matrix}cos θ & sin θ & 0 \\ - sin θ & cos θ & 0 \\ 0 & 0 & 1\end{matrix} ) & [ Expression 3 ]\end{matrix}$$

Under this premises, a planar development of an arbitrary point X on the next return triangle T₂ to the planar development reference plane may be represented by the following equation:

Xₜ=MRM^{T}X+(E−MRM^{T})H (1),

where H is a position vector of point H, and let ^{T} be a transposed matrix.

While a detailed description of this equation will be omitted, the equation represents a calculation for returning a rotation of an angle θ around an axis AB in a local coordinate system formed by v₁, v₂, and v₃ to that in a world coordinate system.

Since the planar development matrices MRM^{T} and (E−MRM^{T})H calculated in the present step are to be also used in subsequent calculations, the planar development matrices MRM^{T} and (E−MRM^{T})H are stored in, for example, the processing data storage unit 17.

The above description concerns the relationship between the triangle T₁ that is the planar development reference plane and the triangle T₂ that is the next return triangle. If the planar development boundary is not reached, a planar development matrix representing the relationship between the triangle T₂ and a further next return triangle T₃ is calculated. If the planar development boundary is still not reached, a planar development matrix representing the relationship between the triangle T₃ and a further next return triangle T₄ is calculated. In this manner, a planar development matrix is repeatedly calculated until the planar development boundary is reached. When the planar development boundary is reached, a planar development matrix regarding a previous return triangle Tₙ₋₁, and a triangle Tₙ, associated with the planar development boundary h and an immediately preceding interpolation point on the path is calculated.

Subsequently, the distance compensation unit 161 uses a planar development matrix to develop vertices A and B at both ends of the edge AB including the return interpolation point r₁, as well as the return interpolation point r₁, onto the planar development reference plane, and stores coordinates that are the processing result in, for example, the processing data storage unit 17 (step S47).

In the present step, coordinates are calculated according to the equation (1). However, the planar development boundary h is normally not reached by one process as is the case of the example illustrated in FIG. 48. In a second process, after performing a calculation using the planar development matrix calculated in the last step S45 and according to the equation (1), a calculation is performed using the obtained coordinates and the planar development matrix calculated in step S45 of the last process and according to the equation (1).

In a third process, a calculation is performed using the planar development matrix calculated in the last step S45 and according to the equation (1), a calculation is performed using the obtained coordinates and the planar development matrix calculated in step S45 of the last process and according to the equation (1), and a calculation is further performed using the obtained coordinates and the planar development matrix calculated in step S45 of the next-to-last process and according to the equation (1). Such processes are repeated.

Subsequently, the distance compensation unit 161 determines whether or not processing has proceeded to the planar development boundary h, in other words, whether or not the next return triangle has become a triangular element to which the planar development segment end point h belongs (step S49). If processing has not proceeded to the planar development boundary h, the processing returns to step S43.

On the other hand, if processing has proceeded to the planar development boundary h, the distance compensation unit 161 inspects whether a straight line connecting the interpolation point existing on the front and a planar development point of the planar development boundary intersects all planar-developed edges existing between the interpolation point existing on the front and the planar development segment end point (step S51). As for the interpolation point h existing on the front illustrated in FIG. 43, it may be seen that not all planar-developed edges are intersected.

Subsequently, the distance compensation unit 161 determines whether a straight line connecting the interpolation point existing on the front and the planar development point of the planar development boundary intersects all planar-developed edges (step S53), and if the straight line does not intersect any of the planar-developed edges, the distance compensation unit 161 sets the immediately preceding return interpolation point of the interpolation point existing on the front on the path in the interpolation point management table (FIG. 46) as the planar development boundary (step S55). If it is determined that conditions are not satisfied in step S53 in this manner, the distance may not be compensated because the planar development boundary and the interpolation point existing on the front are not connected by a straight line. Specifically, using the previous distance compensation and an inter-triangle distance Δd for the distance between the interpolation point existing on the front and an immediately preceding interpolation point (return point), a distance to the interpolation point existing on the front h may be obtained.

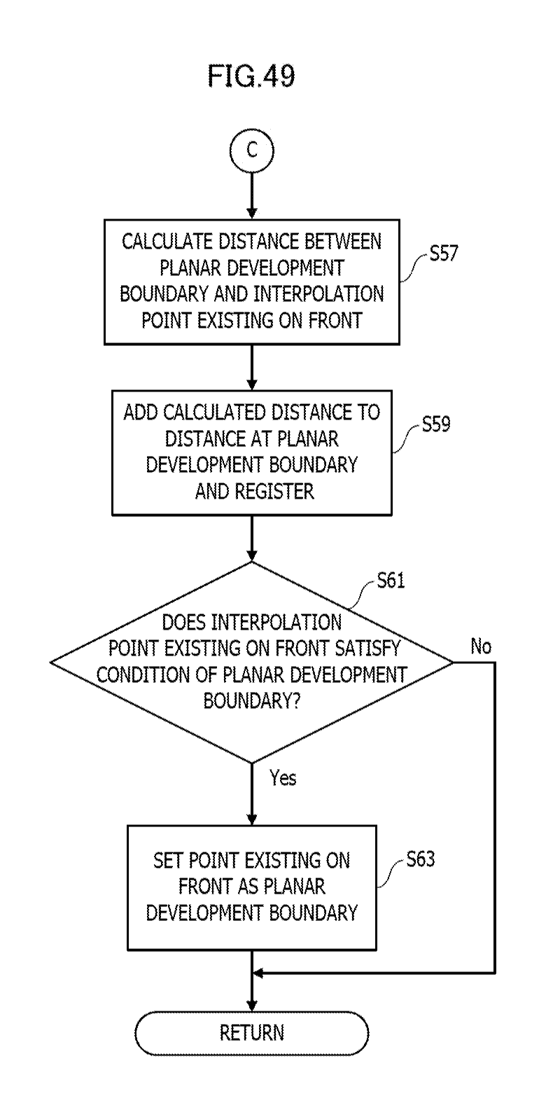

On the other hand, if it is determined that the condition of step S53 has been satisfied, the processing moves via terminal C to the processing illustrated in FIG. 49.

The distance compensation unit 161 then calculates a distance between the planar development boundary and the interpolation point existing on the front, and stores the result in, for example, a storage device such as a main memory (FIG. 49: step S57). Since the calculation of a distance between points is well known, a description will not be given. The distance calculated in step S57 is added to the distance at the planar development boundary stored in the interpolation point management table, and is registered as the path distance of the interpolation point existing on the front in the interpolation point management table (step S59). The distance compensation unit 161 then determines whether the interpolation point existing on the front satisfies condition A or B of the planar development boundary (step S61). If condition A, a determination is made on whether or not conditions A(1) and A(3) are satisfied, and if condition B, a determination is made on whether or not condition B(2) is satisfied. If the conditions are satisfied, the interpolation point existing on the front is set as the planar development boundary in the interpolation point management table (step S63). Subsequently, processing returns to the original processing. If the conditions are not satisfied, step S59 becomes unnecessary and processing returns to the original processing.

By performing processing such as described above, an accurate path distance may be calculated.

In addition to the shortest path search processing described above, the planar development path distance correction processing may also be applied to Dijkstra's algorithm. That is, in the process for searching for one node zεU having a shortest distance d in Dijkstra's algorithm, a triangular mesh is retained as a different data from a weighted graph, whereby the distance d is compensated by performing the same processing on the triangular mesh.

B. Interpolation Point Position Compensation Processing

By planar development path distance correction processing, the position of an interpolation point on a path takes a different position from an initially set position (or assumed position). Therefore, when performing planar development path distance correction processing, interpolation point position compensation processing is preferably performed. However, interpolation point position compensation processing may not necessarily be performed in step S9 as the planar development path distance correction processing, and may be performed only once upon the arrival of the interpolation point existing on the front at the path arrival curve. The following description will be given on the premise that the processing is performed in step S13. However, the processing may be performed together with planar development path distance correction processing.

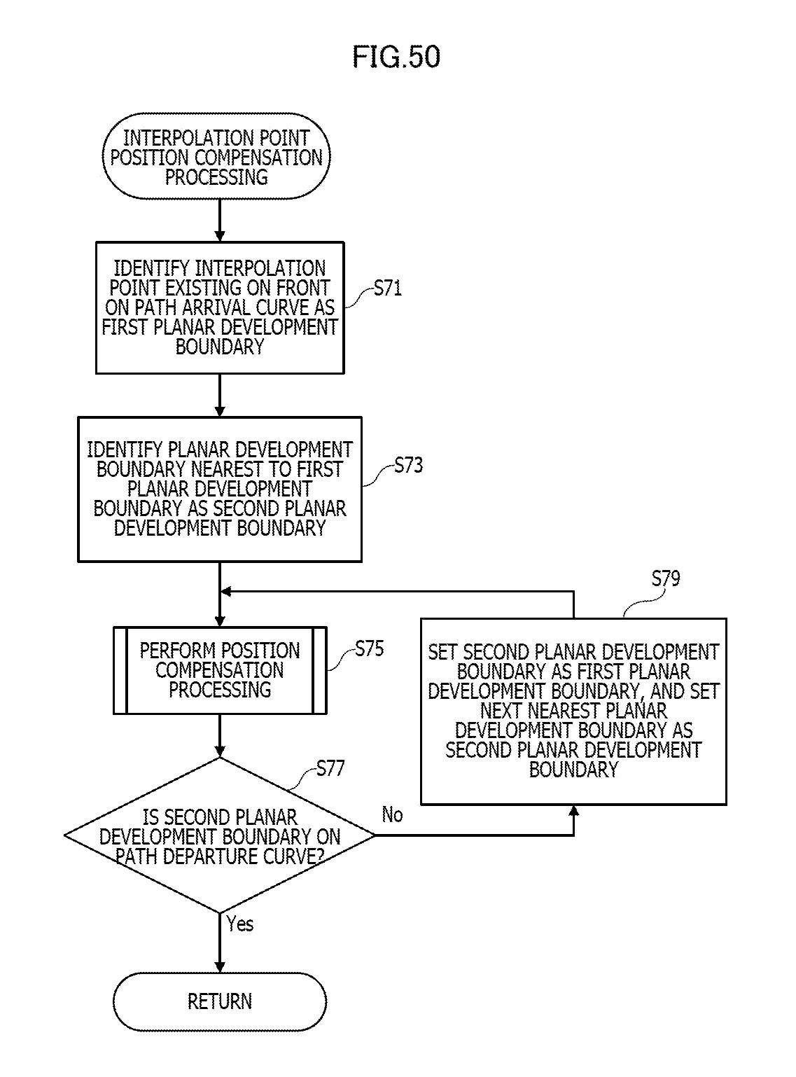

The interpolation point position compensation unit 162 identifies an interpolation point existing on the front on the path arrival curve as a first planar development boundary (FIG. 50: step S71). Thereafter, by sequentially tracing the path starting from a return point of the interpolation point existing on the front on the path arrival curve in the interpolation point management table (FIG. 46), a planar development boundary that is closest to the first planar development boundary is identified as a second planar development boundary (step S73).

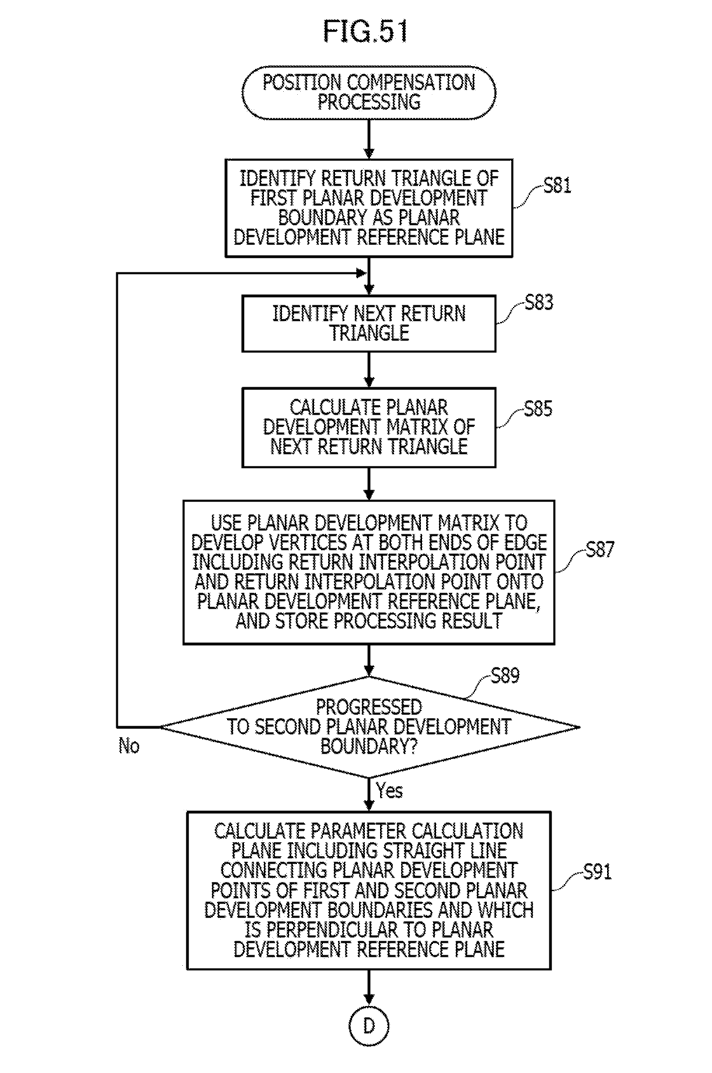

The interpolation point position compensation unit 162 then performs position compensation processing (step S75). This processing will be described with reference to FIGS. 51 to 54. First, the interpolation point position compensation unit 162 identifies a return triangle of the first planar development boundary as a planar development reference plane (FIG. 51: step S81). This step is the same as step S41. A next return triangle is then identified (step S83). This step is the same as step S43. Furthermore, a planar development matrix of the next return triangle is calculated and stored in, for example, the processing data storage unit 17 (step S85). This step is the same as step S45.

Subsequently, the interpolation point compensation unit 162 uses a planar development matrix to develop vertices at both ends of an edge including the return interpolation point on the planar development reference plane, and stores coordinates that are the processing result in, for example, the processing data storage unit 17 (step S87). This step is the same as step S47. However, a development point of a return interpolation point is not necessary.

Subsequently, the interpolation point position compensation unit 162 determines whether or not processing has proceeded to the second planar development boundary or, in other words, whether or not the next return triangle has become a triangular element to which the second planar development boundary belongs (step S89). This step is substantially the same as step S49. If processing has not proceeded to the second planar development boundary, the processing returns to step S83.

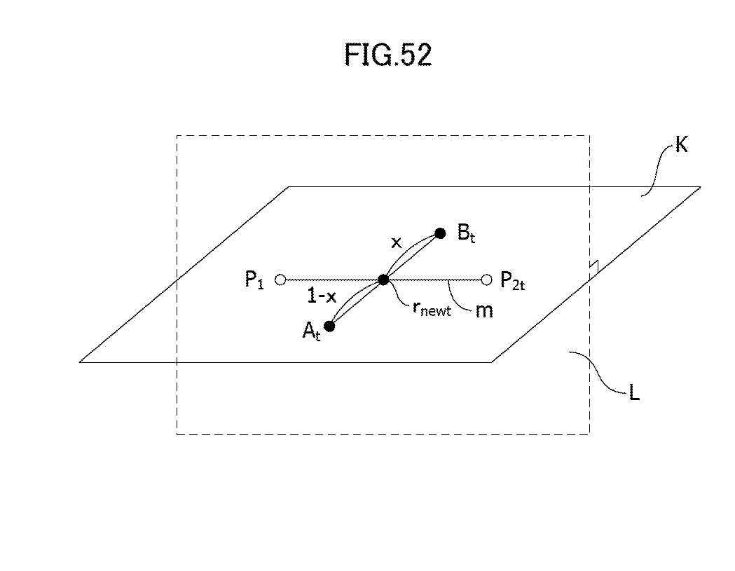

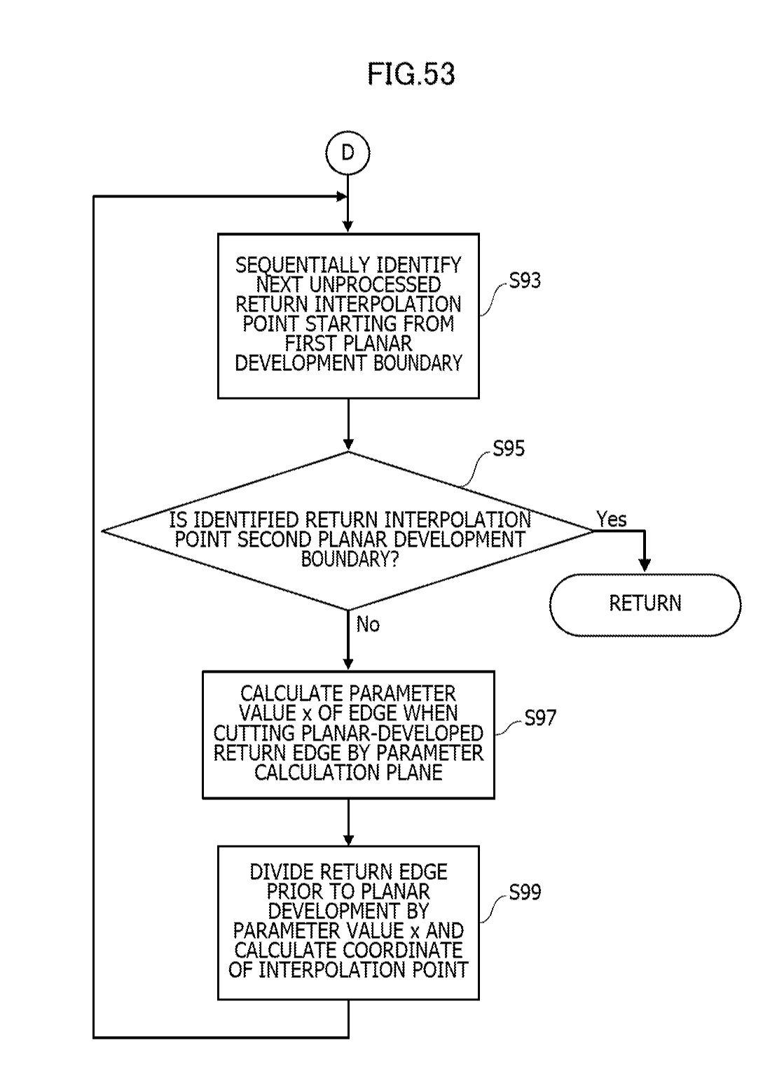

On the other hand, if processing has proceeded to the second planar development boundary, the interpolation point position compensation unit 162 calculates a parameter calculation plane that includes a straight line connecting the planar development points of the first and second planar development boundaries and which is perpendicular to the planar development reference plane (step S91). Specifically, for example, as illustrated in FIG. 52, a first planar development boundary P₁ and a development point P₂ₜ of a second planar development boundary P₂ belong to a planar development reference plane K. In this case, a plane L that includes a line segment m connecting the first planar development boundary P₁ and the development point P₂ₜ and which is perpendicular to the planar development reference plane K is a parameter calculation plane. Moreover, development points Aₜ and Bₜ of an edge AB to which an interpolation point r on a path belongs also exist on the planar development reference plane K. An intersection r_{newt} of a line segment AₜBₜ and the parameter calculation plane becomes a development point of a new interpolation point r_{new} on the edge AB. Processing proceeds via terminal D to the process illustrated in FIG. 53.

After a transition is made to the process illustrated on FIG. 53, the interpolation point position compensation unit 162 sequentially identifies, from the first planar development boundary, a next unprocessed return interpolation point (step S93). The interpolation point position compensation unit 162 then determines whether or not the identified return interpolation point is a second planar development boundary (step S95). If the identified return interpolation point is the second planar development boundary, processing returns to the original process.

On the other hand, if the identified return interpolation point is not the second planar development boundary, the interpolation point position compensation unit 162 calculates an edge parameter x when a return edge to which the identified return interpolation point belong is cut by the parameter calculation plane, and stores the calculated parameter x in, for example, a storage device such as a main memory (step S97). That is, the relationship r_{newt}=(1−x)Aₜ+xBₜ exists, whereby r_{newt} is calculated and a parameter x satisfying the above equation is also calculated.

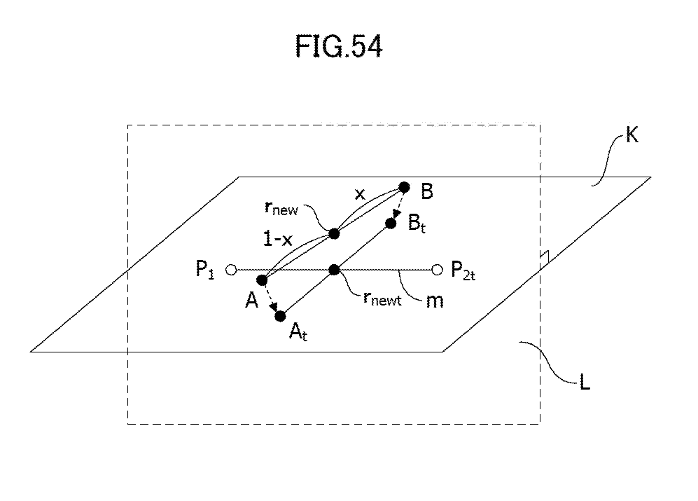

Subsequently, the interpolation point position compensation unit 162 divides the return edge prior to planar development (in other words, the edge to which the identified return interpolation point belongs) by the parameter value x, calculates a new coordinate of the identified interpolation point, and stores the new coordinate in, for example, the interpolation point data storage unit 13 (step S99). That is, as illustrated in FIG. 54, a new coordinate is calculated from the relationship r_{new}=(1−x)A+xB. Processing returns to step S93 where a next return interpolation point is further identified and the process is performed.

By the above processing, an interpolation point position may be compensated at a planar development extent.

Returning now to the process illustrated in FIG. 50, after step S75, the interpolation point position compensation unit 162 determines whether or not the second planar development boundary is an interpolation point on the path departure curve (step S77). If the second planar development boundary is not an interpolation point on the path departure curve, the second planar development boundary is set as a first planar development boundary and a next nearest planar development boundary is set as the second planar development boundary (step S79). A next planar development boundary may be located by searching for a return point in the interpolation point management table. Processing then returns to step S75. On the other hand, if the second planar development boundary is an interpolation point on the path departure curve, processing returns to the original process.

By the above processing, the position of an interpolation point on the path may now be compensated in accordance with a path distance in planar development path distance correction processing.

While an embodiment of the present invention has been heretofore described, the present invention is not limited to the embodiment. That is, for example, the functional block diagram illustrated in FIG. 5 is merely an example and may not be consistent with an actual program module configuration. In addition, functions may be split among a plurality of computers.

Furthermore, as long as processing results do not differ, the execution sequence of the processing steps may be interchanged or the processing steps may be executed in parallel.

Moreover, while an example of a topology table has been presented above using FIG. 10, topological information is not necessarily limited to the topology table illustrated in FIG. 10. Mesh topological information is information representing the connection relationship among triangles, edges, and vertices which make up a mesh and thus many modes of representation exist. A mesh topology representation is a special type of topological structure referred to as a boundary representation (B-Rep) for representing surface domains, edges, and vertices of surfaces of a solid.

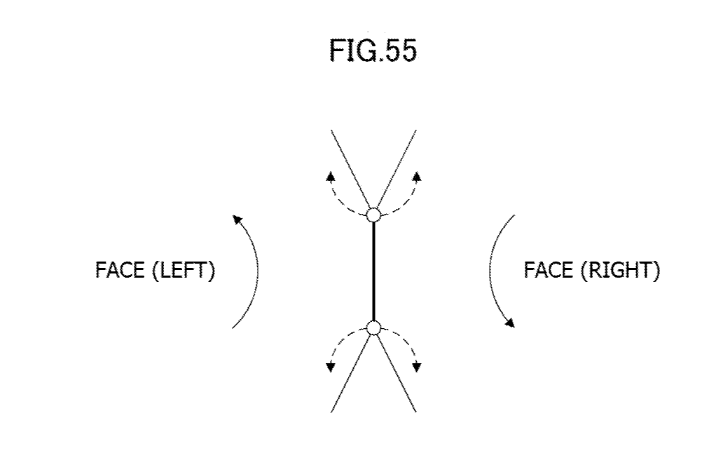

A well known object representation method using boundary presentation is a winged edge structure announced in 1974 by Bruce Guenther Baumgart. As illustrated in FIG. 55, the winged edge structure represents a topological structure of the surface of an object by respectively assigning identifiers to faces (surface domains: in the present description, corresponds to triangles), edges, and vertices, and retaining pointers from each edge to a total of four edges belonging to vertices on both ends, faces on both edges, and faces on both edges which connect to the vertices on both ends.

A winged edge structure is based on edges, whereby the connection relationships of all topological elements of an object are represented using the adjacent relationships between edges and faces and between edges and vertices. According to Weiler, since there are nine ways to select an adjacent relationship, a large number of variations of topological representation exist. Refer to “Kevin Weiler, Edge-Based Data Structure for Solid Modeling in Curved-Surface Environments, IEEE CG&A 1985 January p. 21-40”. When only considering triangular meshes, it is a feature of the mesh representation method described in the present embodiment that the amount of data is smaller than that of a winged edge structure.

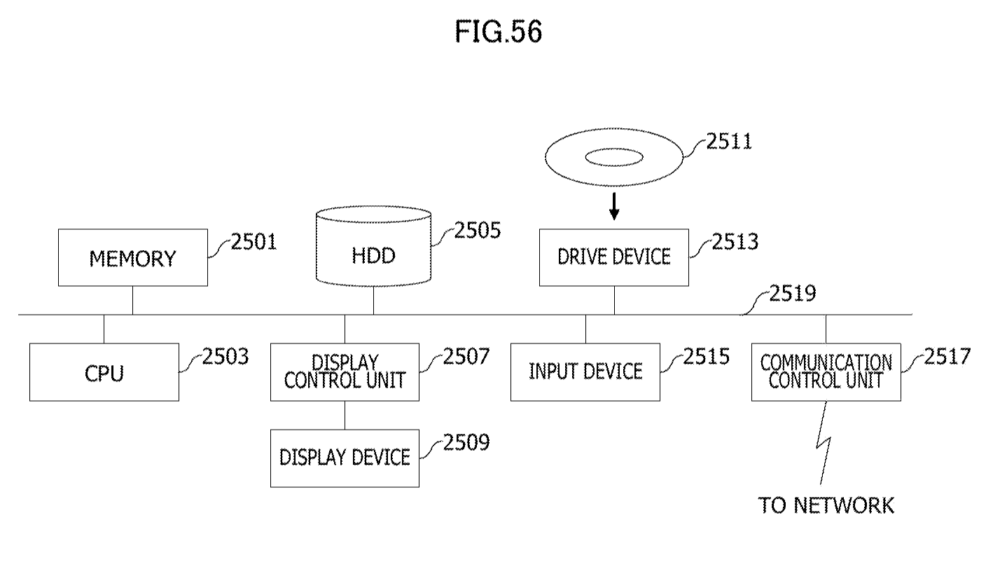

Moreover, a shortest path search device is a computer device in which, as illustrated in FIG. 56, a memory 2501, a CPU 2503, a hard disk drive (HDD) 2505, a display control unit 2507 connected to a display device 2509, a drive device 2513 for a removable disk 2511, an input device 2515, and a communication control unit 2517 for connecting to a network are connected by a bus 2519. An operating system (OS) and an application program for performing processing according to the present embodiment are stored in the HDD 2505 and are read from HDD 2505 to the memory 2501 when executed by the CPU 2503. The CPU 2503 controls and causes the display control unit 2507, the communication control unit 2517, and the drive device 2513 to perform various operations. In addition, data during processing is stored in the memory 2501 and, if necessary, stored in the HDD 2505. In an example of the present invention, the application program for performing the processing described above is stored in and distributed as the computer-readable removable disk 2511, which is then installed in the HDD 2505 from the drive device 2513. In some cases, the application program is installed in the HDD 2505 via a network such as the Internet and the communication control unit 2517. With such a computer device, various functions such as those described above are realized by having hardware such as the aforementioned CPU 2503 and the memory 2501 organically collaborate with the OS and necessary application programs.

The present embodiment described above may be summarized as follows. A shortest path search method for searching for a shortest path on a three-dimensional model with a computer includes the steps of: providing interpolation points on each edge of each triangle of a triangular mesh of the three-dimensional model, associating data on the vertices and interpolation points of the triangles with the data of the corresponding triangles and edges, and storing the associated data in a processing data storage unit; accepting a specification of a one or more departure points or one or more departure curves, and one or more arrival points or one or more arrival curves on the three-dimensional model; and searching the interpolation points and the vertices sequentially from the departure points or the departure curves to the arrival points or the arrival curves based on topological information of the triangular mesh, calculating a distance from the departure points or the departure curves to the interpolation point or the vertex that is a shortest distance search object point, and if the calculated distance is the shortest among all paths, associating the distance with the interpolation point or the vertex that is the shortest distance search object point, and storing the distance in the processing data storage unit.

By adding interpolation points to edges of each triangular element included in a triangular mesh in this manner, accuracy may be improved. In addition, since arcs between interpolation points are not generated, the data volume to be retained may be reduced significantly. Furthermore, since arcs between interpolation points are not generated, calculation time may also be reduced.

Moreover, the searching step described above may be arranged to include a step for storing, in association with the interpolation point or the vertex that is the shortest distance search object point, data for identifying an interpolation point or a vertex immediately preceding the shortest distance search object point on the path in the processing data storage unit. Here, if a shortest distance from the departure points or the departure curves has been registered in the processing data storage unit in association with an arrival point or an interpolation point or a vertex on the arrival curves, the present shortest path search method may be arranged so as to further include a path identifying step for identifying a shortest path by extracting data for identifying an interpolation point or a vertex immediately preceding the shortest distance search object point on the path stored in the processing data storage unit in association with an interpolation point or a vertex on a path, from an arrival point or an interpolation point or a vertex on the arrival curves to a departure point or an interpolation point or a vertex on the departure curves. Consequently, a shortest path may now be identified in addition to a shortest distance.

Furthermore, the searching step described above may be arranged to include a step for storing, in association with the interpolation point or the vertex that is the shortest distance search object point, a return information for identifying an interpolation point or a vertex immediately preceding the shortest distance search object point on the path in the processing data storage unit. When doing so, the searching step may be arranged so that a search destination interpolation point or vertex is identified based on topological information of the triangular mesh and the return information in accordance with a predetermined rule. Consequently, since an appropriate search destination is identified, processing may be performed at a higher speed than during an exhaustive search.

In addition, the searching step described above may be arranged so as to include: a step for identifying, among candidate points whose distances are already stored in the processing data storage unit, and which are stored in a candidate management data storage unit storing data for managing interpolation points and vertices to become candidate points of search sources of a shortest distance search object point, a candidate point that has the minimum distance stored in the processing data storage unit as a search source point of the shortest distance search object point; an identifying step for identifying an interpolation point or a vertex associated with a triangle including the search source point as the shortest distance search object point and storing the shortest distance search object point in the candidate management data storage unit; and a deleting step for deleting the search source point from the candidate management data storage unit if the search for the shortest distance search subject point is completed. Accordingly, a search may be performed efficiently.

Furthermore, the deleting step described above may be arranged so as to include a step for registering data indicating passage completion in the processing data storage unit in association with a search source point. When doing so, in the identifying step, a shortest distance search object point may be arranged so as to be identified by excluding interpolation points or vertices for which data indicating passage completion is registered. Thus, efficient searching may be performed.

Moreover, the searching step described above may be arranged so as to include a distance correcting step for correcting, for at least a part of a path including the shortest distance search object point, a sum of distances between interpolation points or vertices to a linear distance between ends of the part of the path when a triangle associated with the part of the path is subjected to planar development. Consequently, the accuracy of distances may be increased.

Furthermore, the processing data storage unit may be arranged so as to register data indicating a planar development boundary in association with an interpolation point or a vertex which is an end point of an extent for which a linear distance may be calculated. Here, the distance correcting step may be arranged so as to include: a step for projecting an interpolation point or a vertex on a planar development extent from a shortest distance search object point to a nearest planar development boundary and an edge of a triangle associated with the interpolation point or the vertex onto a plane that includes a triangle including the shortest distance search object point and an interpolation point or a vertex immediately preceding the shortest distance search object point on a path; a determining step for determining whether or not a line segment connecting the shortest distance search object point and the planar development boundary on the plane intersect all the edges of a triangle on which the interpolation point or the vertex on the planar development extent is positioned; and a step for calculating, if the condition of the determining step is satisfied, a linear distance from the shortest distance search object point to the planar development boundary, adding the linear distance to a distance stored in the processing data storage unit in association with the planar development boundary, and registering the addition result in the processing data storage unit in association with the shortest distance search object point. Consequently, the accuracy of distances may be increased.

In addition, the distance correcting step described above may be arranged so as to include: if the condition of the determining step is not satisfied, a step for registering data indicating a planar development boundary in association with an interpolation point immediately preceding the shortest distance search object point on the path in the processing data storage unit; and, if the condition of the determining step is satisfied, a step for determining whether the shortest distance search object point satisfies predetermined conditions of a planar development boundary, and if so, registering data indicating a planar development boundary in association with the shortest distance search object point in the processing data storage unit. Consequently, planar development may be performed over an appropriate range.

The conditions of the determining step described above may include a condition preferably requiring a vertex of a triangular mesh. This is because a vertex may become a characteristic point with respect to shape.

Furthermore, the path identifying step described above may be arranged so as to include a step for compensating, at least for a part of a path including the shortest distance search object point, interpolation points of the part of path, to intersection points between a second plane including a line segment connecting both ends of a part of the path when subjecting a triangle associated with the part of the path to planar development and which is perpendicular to a plane after planar development, and edges of the triangle associated with the part of the path. Consequently, an appropriate interpolation point position may be identified.

Moreover, refraction may be arranged to be set to triangles in the triangular mesh described above. In this case, the distance described above is calculated using the refraction of the triangles on the path. For example, when insulation indexes differ among parts of a three-dimensional model, a creepage distance may be calculated appropriately by calculating distances while taking the insulation indexes into consideration.

A program that causes hardware to perform the processing described above may be created. The program is to be stored in, for example, a computer-readable storage medium or a storage device such as a flexible disk, a CD-ROM, an magneto-optical disk, a semiconductor memory, and a hard disk. Data during processing is to be temporarily stored in a storage device of a computer such as a memory.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A shortest path search method for searching for a shortest path on a three-dimensional model executed by a computer, the shortest path search method comprising:
providing interpolation points on each edge of each triangle of a triangular mesh of the three-dimensional model;
storing, in a processing data storage unit, data on vertices of each triangles and data on the interpolation points with the data of the corresponding triangles and edge;
accepting a specification of a departure point or a departure curve and an arrival point or an arrival curve on the three-dimensional model; and
searching the interpolation points and the vertices sequentially from the departure point or the departure curve to the arrival point or the arrival curve based on topological information of the triangular mesh, calculating a distance from the departure point or the departure curve to the interpolation point or the vertex that is a shortest distance search object point, and if the calculated distance is the shortest among all paths, associating the calculated distance with the interpolation point or the vertex that is the shortest distance search object point, and storing the calculated distance as a shortest distance in the processing data storage unit.

2. The shortest path search method according to claim 1, wherein
the searching further includes a first storing step storing data for identifying the interpolation point or the vertex immediately preceding the shortest distance search object point on the path in association with the interpolation point or the vertex that is the shortest distance search object point, in the processing data storage unit; and
the shortest path search method further including, a path identifying step identifying a shortest path, if the shortest distance from the departure point or the departure curve has been registered in the processing data storage unit in association with the arrival point or the interpolation point on the arrival curve or the vertex on the arrival curve, by extracting data for identifying the interpolation point or the vertex immediately preceding the shortest distance search object point on the path stored in the processing data storage unit in association with the interpolation point or the vertex on a path from the arrival point or the interpolation point on the arrival curve or the vertex on the arrival curve to the departure point or the interpolation point on the departure curve or the vertex on the departure curve.

3. The shortest path search method according to claim 1, wherein
the searching further includes a second storing step storing, in association with the interpolation point or the vertex that is the shortest distance search object point, return information for identifying the interpolation point or the vertex immediately preceding the shortest distance search object point on the path in the processing data storage unit; and
the searching further identifying the interpolation point or the vertex that is a search destination based on the topological information of the triangular mesh and the return information in accordance with a predetermined rule.

4. The shortest path search method according to claim 1, wherein
the searching further includes:
a first identifying step identifying a candidate point whose distance stored in the processing data storage unit is the shortest as a search source point of the shortest distance search object point among the candidate points whose distances are already stored in the processing data storage unit and which are stored in a candidate management data storage unit storing data for managing interpolation points and vertices which will become candidates points of search sources of the shortest distance search object point;
a second identifying step identifying the interpolation point or the vertex associated with a triangle including the search source point as the shortest distance search object point and storing the shortest distance search object point in the candidate management data storage unit; and
a deleting step deleting the search source point from the candidate management data storage unit when the search for the shortest distance search object point is completed.

5. The shortest path search method according to claim 4, wherein
the deleting step further includes a registering step registering data indicating passage completion in the processing data storage unit in association with the search source point, and
in the second identifying step, identifying the shortest distance search object point by excluding the interpolation points or the vertices for which data indicating the passage completion is registered.

6. The shortest path search method according to claim 1, wherein
the searching step further includes
a distance correcting step correcting a sum of distances between the interpolation points or the vertices to a linear distance between both ends of a part of a path when a triangle associated with the part of the path is subjected to planar development, for at least the part of the path including the shortest distance search object point.

7. The shortest path search method according to claim 6, wherein
data indicating a planar development boundary in association with the interpolation point or the vertex which is an end point of an extent for which a linear distance can be calculated is registered in the processing data storage unit, and
the distance correcting step further includes:
a projecting step projecting the interpolation point or the vertex on a path from the shortest distance search object point to a nearest planar development boundary, and an edge of a triangle associated with the interpolation point or the vertex onto a plane that includes the shortest distance search object point and a triangle including the interpolation point or the vertex immediately preceding the shortest distance search object point on the path;
a first determining step determining whether a line segment connecting the shortest distance search object point and the planar development boundary on the plane intersects all edges, which are between the shortest distance search object point and the planar development boundary, of the triangle on which the interpolation point or the vertex on the path is positioned; and
a first registering step calculating a linear distance from the shortest distance search object point to the planar development boundary by adding the linear distance to the distance stored in the processing data storage unit in association with the planar development boundary, and registering the result of the addition in the processing data storage unit in association with the shortest distance search object point, when a condition of the first determining step is satisfied.

8. The shortest path search method according to claim 7, wherein
the distance correcting step further includes:
a second registering step registering the data indicating the planar development boundary in association with the interpolation point immediately preceding the shortest distance search object point on the path in the processing data storage unit, if the condition of the first determining step is not satisfied;
a second determining step for determining whether the shortest distance search object point satisfies predetermined conditions of the planar development boundary; and
a third registering step registering the data indicating the planar development boundary in association with the shortest distance search object point in the processing data storage unit, if the condition of the second determining step is satisfied.

9. The shortest path search method according to claim 7, wherein
the conditions of the second determining step includes a condition of a vertex of the triangular mesh.

10. The shortest path search method according to claim 2, wherein
the path identifying step includes a changing step changing, for at least a part of a path including the shortest distance search object point, the interpolation point of the part of the path to an intersection of a second plane which includes a line segment connecting both ends of a part of the path when subjecting a triangle associated with the part of the path to planar development and which is perpendicular to a plane after the planar development, and an edge of the triangle associated with the part of the path.

11. The shortest path search method according to claim 1, wherein
refraction index is set for the triangles in the triangular mesh, and the distance is calculated using the refraction index of the triangles on the path.

12. A computer-readable medium for recording a shortest path search program allowing a computer to execute steps of:
providing interpolation points on each edge of each triangle of a triangular mesh of the three-dimensional model;
storing, in a processing data storage unit, data on vertices of each triangles and data on the interpolation points with the data of the corresponding triangles and edge;
accepting a specification of a departure point or a departure curve and an arrival point or an arrival curve on the three-dimensional model; and
searching for the interpolation points and the vertices sequentially from the departure point or the departure curve to the arrival point or the arrival curve based on topological information of the triangular mesh, calculating a distance from the departure point or the departure curve to the interpolation point or the vertex that is a shortest distance search object point, and, if the calculated distance is the shortest among all paths, associating the distance with the interpolation point or the vertex that is the shortest distance search object point, and storing the distance as a shortest distance in the processing data storage unit.

13. A shortest path search device for searching for a shortest path on a three-dimensional model, the shortest path search device comprising:
a triangular mesh data storage unit for topological data of a triangular mesh including topological information on the triangular mesh;
a processing data storage unit storing associated data in the processing data storage unit, the associated data being an association of data on vertices and data on interpolation points of the triangles with data of the corresponding triangles and edges, the interpolation points provided on each edge of each triangle of the triangular mesh of the three-dimensional model which is stored in the triangular mesh data storage unit;
a data input unit accepting a specification of a departure point or a departure curve and an arrival point or an arrival curve on the three-dimensional model; and
a search processing unit searching for the interpolation point and the vertices sequentially from the departure point or the departure curve to the arrival point or the arrival curve based on topological information of the triangular mesh, calculating a distance from the departure points or the departure curve to the interpolation point or the vertex that is a shortest distance search object point, and if the calculated distance is the shortest among all paths, associating the distance with the interpolation point or the vertex that is the shortest distance search object point, and storing the distance as a shortest distance in the processing data storage unit.
